(19) United States
(12) Patent Application Publication
(10) Pub. No.: US 2016/0098778 A1
(43) Pub. Date: Apr. 7, 2016

(54) METHOD, DEVICE, AND SYSTEM FOR ANALYZING AND RANKING PRODUCTS

(71) Applicant: Jemstep, Inc., Los Altos, CA (US)

(72) Inventors: Michael Blumenthal, Johannesburg (ZA); Matthew Rennie, Mountain View, CA (US)

(21) Appl. No.: 14/971,416

(22) Filed: Dec. 16, 2015

Related U.S. Application Data
(63) Continuation of application No. 12/971,640, filed on Dec. 17, 2010.
(60) Provisional application No. 61/291,618, filed on Dec. 31, 2009.

(51) Int. Cl. G06Q 30/06; G06F 17/30

(52) U.S. Cl. CPC G06Q 30/0631; G06F 17/3053; G06F 17/30528; G06F 17/30867

(57) ABSTRACT

A method, system, and computer program product for locating a relevant product via a computer network includes receiving, at a client terminal, a search topic from a user and one or more attributes associated with the topic and assigning a rating to at least one of the attributes. A server is used to locate, at one or more information locations, at least two separate instances of the topic and at least two information fields, each field related to one of the instances the topic. Content in each of at least two of the information fields is associated with at least one of the attributes and the content in each of the at least two information fields associated with an attribute is compared against each other. A score to the content of each compared instance of content is assigned based on the comparing. The attributes are prioritized and the located instances of the topic are ranked based on the prioritizing and the score of content associated with the topic.

### CROSS-REFERENCE

This application claims the benefit of U.S. Provisional Application No. 61/291,618, filed Dec. 31, 2009, which is incorporated herein by reference in its entirety.

This application is related to the following co-pending patent application: application Ser. No. 11/769,138, titled “Method, Device, and System for Analyzing and Ranking Web-Accessible Data Targets”, filed Jun. 2, 2007, which published as U.S. Patent Publication No. 2009/0006216 on Jan. 1, 2009, and which is incorporated herein by reference.

### FIELD OF THE INVENTION

The present invention relates generally to internet content location and ranking, and, in particular, to ranking products based on criteria relevant and customized to each particular user and their need for the product.

### SUMMARY OF THE INVENTION

In an example embodiment, a system, method, and computer program product for locating a relevant product via a computer network includes receiving a search topic from a user, where the topic is a particular product that the user is looking for. One or more attributes associated with the topic is then received. The attributes can be properties of the product, such as interest rate of a credit card or certificate of deposit, or can be a property of the user, such as cash flow or debt of the user. A rating is then assigned to at least one of the attributes, where one attribute may be defined as more important than another attribute. Information locations are searched until at least two separate instances of the topic are located. At each of the information locations where an instance of the topic is located, an information field related to one of the instances the topic is located. Next, content in each of at least two of the information fields is associated with at least one of the attributes and the content in a first one of the information fields is scored against the content in a second one of the information fields. The attributes are then prioritized and the located instances of the topic are ranked based on the prioritizing.

In accordance with another feature of an example embodiment of the present invention, the receiving one or more attributes associated with the user comprises receiving inputs from a user, searching data stored during the user's previous session, searching a database of user attributes, and/or system default settings.

In accordance with yet another feature an example embodiment of the present invention, the attributes comprise an income, a credit score, and/or a location.

In accordance with a further feature, an embodiment of the present invention includes displaying by rank, one or more of the plurality of ranked results.

In accordance with one additional feature, an embodiment of the present invention includes updating the rank of the plurality of results in response to receiving a change to a priority of at least one of the attributes.

In accordance with another feature, an embodiment of the present invention includes receiving a user rating of a product and ranking the plurality of results of the searching based at least in part on the user rating.

In accordance with still another feature, an example embodiment of the present invention provides a system for locating a relevant product, where the system includes a client computer operable to receive a search topic from a user and receive one or more attributes associated with the user. The system also includes a server communicatively coupled to the client computer and operable to search two or more information locations for the search topic and at least one information field related to the topic. Either the client computer or the server associates at least one of the information fields with at least one of the attributes, prioritizes the attributes, and/or ranks a plurality of results of the searching based on the priority of the attributes.

Another example embodiment provides a computer implemented method for ranking a plurality of products. A plurality of attribute groups may be specified, wherein each attribute group is associated with a plurality of product attributes. A series of questions associated with each attribute group may be presented to the user and responses may be obtained for the user for each series of questions. The responses may be sent from a client computer to a server for processing. At the server, a set of rules may be applied to the responses obtained from the user to generate weightings for the product attributes in the attribute group associated with the respective series of questions. Each of the products may be scored for each of the product attributes. Weighted scores may be generated by applying the weighting for the respective product attribute to the score for the respective product attribute for each of the products and the products may be ranked or sorted based on the weighted scores.

In an example embodiment, each rule may include a condition based on a respective response from the user and an action to be taken if the condition is met, wherein the actions specified by the rules include adjusting weightings for product attributes in the attribute group associated with the respective question. The actions specified by some of the rules may also include generating a filter based on a product attribute in the attribute group associated with the respective question.

In an example embodiment, multiple modes of operation may be provided. Different modes of operation may be provided for beginner users, advanced users and expert users. The series of questions associated with each attribute group and the rules that are applied to the responses to the series of questions may vary between the different modes of operation. In an example embodiment, the number or level of detail of questions associated with an attribute group may vary based on the mode of operation. In some embodiments, the rules associated with each question in the attribute group for a first mode of operation may result in an adjustment of the weightings for a larger number of product attributes than the rules associated with each question in the attribute group for a second mode of operation. An expert mode of operation may also be provided that permits a user to specify a weighting for each product attribute.

In an example embodiment, the range of adjustments to the weightings for a product attribute or attribute group permitted is a first mode of operation may be more limited than the range of adjustments permitted in a second mode of operation. As a result, a beginner mode may have more constraints on adjustments to the weightings or deviations from default values than a more advanced mode of operation. In addition, in some embodiments, the total weightings for a first attribute group relative to the total weightings for a second attribute group may be constrained for some modes of operation. The level of constraint may decrease for more advanced modes of operation. If the weightings generated by the rules result in a total weighting for the group that is outside of the constraint, the weightings for the attributes in the group may be adjusted until the constraint is met. These constraints may be relaxed for a more advanced mode and may be eliminated altogether in an expert mode.

In some embodiments, the mode of operation may be selected for each attribute group. As a result, the questions and rules applied to some attribute groups for a user may be based on a beginner mode and the questions and rules applied to other attribute groups may be based on a more advanced mode.

In example embodiments, the level of detail of the questions and correlation of the questions to individual product attributes may increase as the mode of operation becomes more advanced.

In example embodiments, a rule may adjust the weightings for multiple product attributes in response to a response to a single question. For example, in beginner modes, the user may answer general questions and the rules may make a number of individual adjustments to weightings for various product attributes based on the user's response. In addition, the series of questions associated with an attribute category may result in numerous incremental adjustments to weightings for the same product attribute. The user only needs to answer a series of high level questions. The user does not need to be exposed to the complexity of the detailed adjustments to individual product attributes that may be made based on those responses. However, in some embodiments, backtracking information is provided to the user. The backtracking information includes information about how each response impacted the weightings used to generate the rankings provided to the user.

In example embodiments, each product may be scored for purposes of ranking. The product may be scored for each product attribute and the score may be weighted by the weightings generated based in the user's response to questions. Data values for each product attribute for each product may be retrieved from a database or other data storage for scoring. In example embodiments, scoring for at least some of the attributes includes scoring against a benchmark. Scoring against the benchmark may include evaluating a logical operator applied to the data value for the product attribute for the product being scored relative to the benchmark value for the respective product attribute. Scoring for at least some of the attributes may also includes scoring against peer products. For example, the score for at least some of the attributes may be based on the number of standard deviations from a mean value for the product attribute for peer products.

In example embodiments, scoring may also include generating an optimal score for each product attribute. The optimal scores may also be weighted to provide an optimal fit for the preferences expressed by the user in responding to the questions. A fit for the weighted scores for each product relative to the optimal fit may also be determined and used to rank or sort the products in example embodiments.

In example embodiments, the above features may be used individually or in combination with one another.

Example embodiments may include a computer system having at least one processor, at least one memory, and at least one program module, the program module stored in the memory and configured to be executed by the processor, wherein the at least one program module includes instructions for performing one or more of the features described above.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with example embodiments of the present invention.

FIG. 1 is a diagrammatic representation of a networked system of data processing components in which example embodiments of the present invention may be implemented.

FIG. 2 is a flow diagram showing information location steps in accordance with an exemplary embodiment of the present invention.

FIG. 3 is a screen shot of a sample page body layout in accordance with an exemplary embodiment of the present invention.

FIG. 4 is a screen shot of a sample location-refinement screen in accordance with an exemplary embodiment of the present invention.

FIG. 5 is a screen shot of a sample page for setting attributes associated with a user in accordance with an exemplary embodiment of the present invention.

FIG. 6 is a screen shot of a sample page for inputting detailed attributes in accordance with an exemplary embodiment of the present invention.

FIG. 7 is a screen shot of a sample search results presentation page in accordance with an exemplary embodiment of the present invention.

FIG. 8 is a screen shot of a product ranking tool in accordance with an exemplary embodiment of the present invention.

FIG. 9 is a screen shot of an interaction summary page in accordance with an exemplary embodiment of the present invention.

FIG. 10 is a block circuit diagram of a data processing system that may be implemented as a server computer system in accordance with an exemplary embodiment of the present invention.

FIG. 11 is a block circuit diagram of a data processing system that may be implemented as a client computer system in accordance with an exemplary embodiment of the present invention.

FIG. 12 is a screen shot of a sample page body layout for searching and ranking mutual funds in accordance with an exemplary embodiment of the present invention.

FIG. 13 is a screen shot of a sample ratings-definition screen in accordance with an exemplary embodiment of the present invention.

FIG. 14 is a screen shot of a filter settings screen in accordance with an exemplary embodiment of the present invention.

FIG. 15 is a screen shot of a sample page body layout for searching and ranking mutual funds in accordance with an exemplary embodiment of the present invention.

FIG. 16 is a screen shot of a sample search results presentation page for mutual fund families in accordance with an exemplary embodiment of the present invention.

FIG. 17 is a screen shot of a sample page body layout for searching and ranking certificates of deposit in accordance with an exemplary embodiment of the present invention.

FIG. 18 is a block diagram illustrating an example product ontology for mutual fund products according to an example embodiment.

FIG. 19 is an example table illustrating product attributes and attribute groups for mutual fund products according to an example embodiment.

FIG. 20 is a diagram illustrating an overview of the operation of a system according to an example embodiment.

FIG. 21 is an example screen display for defining question properties and possible answers according to an example embodiment.

FIG. 22 is a flow chart illustrating an example question flow according to an example embodiment.

FIG. 23 shows an example decision table according to an example embodiment.

FIG. 24 is a flow chart illustrating an example method for ranking products according to an example embodiment.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

Described now is an exemplary embodiment for a method and hardware platform for intelligently locating a product, where the search for the product is performed over a computer network and the located product is selected by its relevance to a searcher and, more particularly, by its correlation to attributes associated with the searcher. Embodiments of the present invention locate not just web pages that reference, link, or offer a desired product, but returns a list of results ranked by how well the product fits the searcher's needs and the searcher's situation. The term “product,” as user herein, is defined broadly and refers not only to physical objects, but also to services, and combinations of products and services, such as credit cards.

### Network

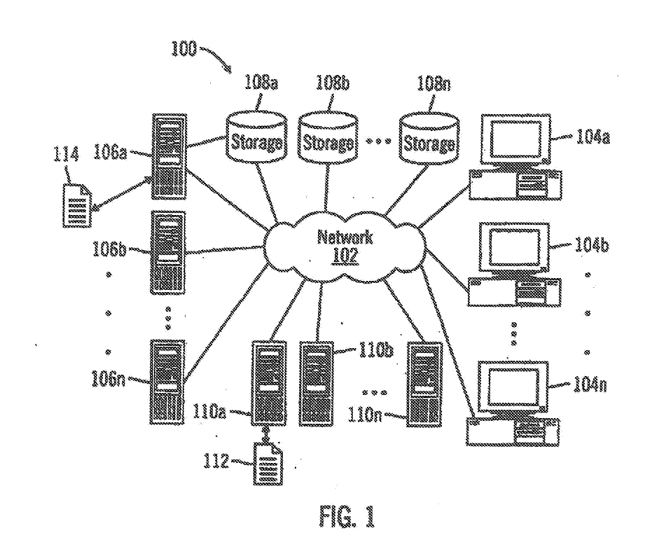

With reference now to the figures, FIG. 1 is a pictorial representation of a networked system 100 of data processing components in which embodiments of the present invention may be implemented. The system 100 includes a network 102, which is the medium used to provide communications links between various devices and computers connected together within the networked data processing system 100. The network 102 provides communication between a plurality of user computers 104a to 104n and a plurality of information servers 106a to 106n. The network 102 is, for example, the internet and provides on-line services. The network servers 106a to 106n manage network traffic such as the communications between any given user's computer 104 and an information server 106. The network 102 may include wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with embodiments of the present invention.

The user computers 104 are equipped with communications software, including a World Wide Web (WWW) browser such as, for example, the NETSCAPE® browser made by the NETSCAPE COMMUNICATIONS®, INTERNET EXPLORER® made by MICROSOFT®, and FIREFOX® by MOZILLA®, that allows a searcher to connect and use on-line searching services via the Internet. The software on a user computer 104 manages the display of information received from the servers 106 to the user computer 104 and communicates user's actions back to the appropriate information servers 106 so that additional display information may be presented to the user or the information acted on.

In the depicted example of FIG. 1, servers 106a-n are connected to network 102 along with storage units 108a-n. The storage units 108a-n hold data and are searchable by and accessible to the servers 106a-n via the network 102. As an alternative one or more of the storage units 108a-n may be coupled directly to one of the servers 106a-n, by, for instance, a link 112.

The servers illustrated in FIG. 1, and discussed hereafter, are those of product or service provider, i.e. a merchant. While the following discussion is directed at communication between shoppers and merchants over the Internet, it is applicable to any information seeker and any information provider on a network. (For instance, the information provider can be a library such as a University library, the public library, or the library of Congress or other type of information providers.) Information regarding a merchant and the merchant's products or services is stored in one of the databases 108a-n, to which the merchant servers 106a-n have access. This may be the merchant's own database or a database of a supplier of the merchant.

In addition to the servers of individual merchants 106, and other information providers, the system 100 also includes a plurality of search servers 110a-n provided by search service providers, such as GOOGLE®, which maintain full text indexes 112 of the products of the individual merchants 106a-n obtained by interrogating product information databases 114 maintained by the individual merchants. Some of these search service providers, like GOOGLE®, are general purpose search providers while others are topic specific search providers.

Network data processing system 100 may include additional servers, clients, and other devices not shown. In the depicted example, network data processing system 100 includes the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

### Information Location

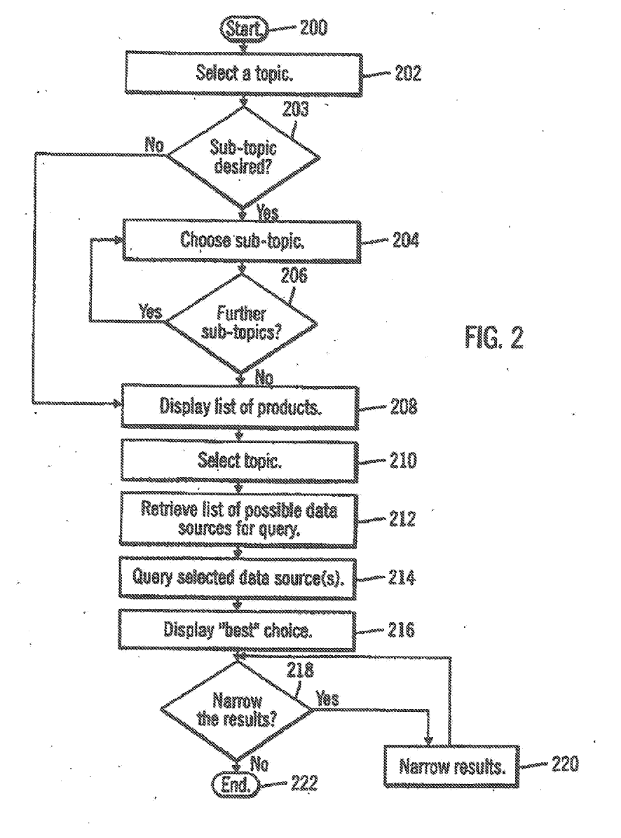

One example embodiment is a web-based search application that runs on one of the client devices 104 alone or in conjunction with one or more servers 110, 106. FIG. 2 shows a process flow diagram of the steps for information location performed by an embodiment of the present invention. The process begins at step 200 and moves directly to step 202 where a user selects a topic by typing, clicking from a given list of topics, or any of multiple other ways of selecting a topic. A few exemplary topics include mutual funds. automobiles, real estate, jobs, finance, and others. Once a topic is selected, a list of sub-topics, if applicable (step 203), will then be selectable by the user in step 204. For example, the first topic might be “Finance” and a sub-topic of finance would be “Banking.” From there, further sub-topics can be selected until, finally, a product, such as “Credit Card,” for example, is chosen.

In step 206, a query is made as to whether further sub-topics are to be selected. If the answer to step 206 is yes, the flow moves back to step 204 and a further sub-topic is selected. If the answer to the query of step 206 is no, the flow continues to step 208 where, now that a topic and a sufficient number of sub-topic levels have been traversed, a list of products is displayed, with each product being selectable by the user. In step 210, a user selects one of the topics.

Once a product is selected, in step 212, a list of possible data sources for the query is retrieved. The system advantageously collects data from multiple sources. These sources ate either static or dynamic, online or offline, or both. Some interactions with data sources will need to be dynamic, for example, interacting with the website of an airline to trawl flight availability. Depending on the nature of the search topic, this may be one or a combination of: a local data store where product information is cached and updated periodically either through push or pull techniques; a web service or application programming interface (API), whereby product information is generated dynamically based on variable inputs; or a web application, whereby product information is generated dynamically and requires system interaction with the web site in order to reach a final result. For instance, if the provider of the product offers an online facility to apply, order, or gain more information about the product, the system, in accordance with one embodiment, is able to automatically glean pertinent information from the provider's resources.

The ability for the backend systems to know where to collect data from on a query-by-query basis and to determine if the data is stored locally or is dynamic and global is managed by a data collection component. This component is also responsible for the caching and cache management of data.

In step 214, the data source(s) selected is/are queried. Querying can be performed in several different ways. One example of this is web scraping, which can be performed, for instance, by a semi-trained agent. Web scraping with a semi-trained agent involves a web robot tailored to meet the data presentation formats of a specific provider. This type of robot is most effective with a limited number of providers or in an instance where an intermediary party presents data collected from multiple sources in a similar format. Examples of these would be airline websites, consumer watchdog websites, and financial portals. Scraping occurs after the document object model of the web page has been generated, and is not merely scraping data from raw markup languages.

The training stage of a robot involves processing each seed with a monitor that watches human interactions with the website. Required input variables are linked to object structures which contain user data, for example, unknownPage.Document.Form.INPUT_TEXT_PASSENGER_LASTNAME=FirsName, LastName. The agent simulates the steps for each new query and moves to the specified results page. The results are scraped and combined into the products' attributes and are ready for the ranking function. Table parsing mechanisms are used to extract data cleanly. The data can be periodically updated and structural changes to the source are flagged.

Another data-acquisition method is through use of source discovery and untrained data collection. Source discovery involves the processes used by meta-search engines to locate sources of data which may be relevant. By parsing the results of multiple search engines, the agent attempts to identify possible sources of relevant information and generates a seed list. The agent then visits the seeds and attempts to extract and verify data by one or more of the following:
Visually grouping elements on the page to determine navigation features and page elements which may contain data.
Attempting syntactical word analysis and simple word matching within the visual groups to locate links to data sources and possible product attributes.
If data is tabular, it attempts to scrape the data and match the fields to the relevant tables.
If data is not tabular, but there is an accuracy match above 40%, the agent flags the seed and resulting page for training.

A few other data collection methods include data sharing schemes and pushed or submitted data. By either purchasing data or participating in revenue-sharing schemes, embodiments of the invention can obtain access to data collected by market researchers or data providers. With pushed or submitted data, providers can submit their own product details to embodiments of the present invention by using an API.

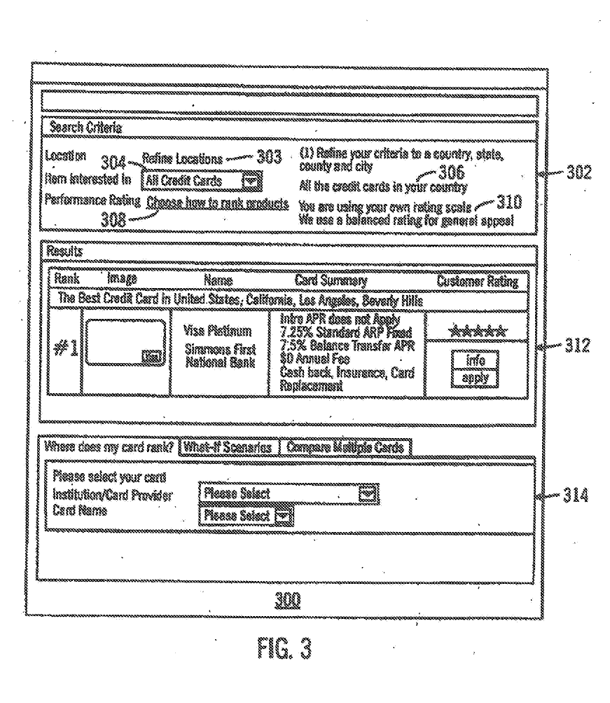

An example of a query performed by an embodiment of the present invention could include the user's location information and/or the importance of a particular attribute of the product, which can be set by system defaults or through user interaction. In step 216, the system automatically displays the “best” choice for the particular product selected by the user. The best of a particular product is represented, in one embodiment of the present invention, in a multi-tiered structure. For example, tier 1 (row 1) can state “The best CD in the country, based off your criteria is: ExampleBank1 High Yield CD.” Tier 2 (row 2) can state, “The best in your state is ExampleBank2 CD.” This may be the case if, for example, the state is Alabama, but ExampleBank1 does not have a presence in Alabama. Finally, Tier 3 (row 3) can state “The best CD in your town,” (where ExampleBank1+ExampleBank2 do not have a presence) “is ExampleBank3 CD.” When the result in tier 2 matches tier 1, the tiers are merged into one, and so on, as in the screenshot FIG. 3.

The determination of “best,” in accordance with embodiments of the present invention, varies depending on many factors. In example embodiments, the determination dynamically changes based on the attributes used for the search and the hierarchy of these attributes. For instance, for a product that is relevant to a location, the “best” selection may be based on the best in a country, the best in a particular state, and/or the best in a user's geographical area. Continuing with the example of credit card as the desired product, the determination of “best” may turn on factors such as:
Annual percentage rate (APR).
Introductory interest rate.
Balance transfer fees.
Transaction fees.
Annual fees.
Card sponsors.
Security measures.
Rewards program.
Consumer rating of the card.
Geographical are in which the institution operates within.

Each of these factors is found in information fields associated with the product. Information fields are any data area on a page connected to a product. For a product relevant to time (e.g., stocks, bond, currencies, etc), rankings may be based on current statistics, best of the day statistics, monthly or yearly numbers, and others.

In step 218, the user is queried as to whether or not the results should be narrowed. If the answer to the query of 218 is yes, the list can be narrowed, in step 220, automatically or manually, by, for instance, selecting only those products which are offered within a specified distance from the user's location or another defined location. From step 220, the flow moves back to step 218. In step 218, the searcher is given the option to narrow the search results even further. The search may be further narrowed by choosing or adjusting a user attribute, e.g., a poor credit history, or no credit record, or a product attribute, e.g., the card must allow for 0% APR on balance transfers. In addition, a ranking of the importance of attributes defined for the user or the product can factor into the final product ranking. An example search result would be: “Within your region X (may be broken down into country, state, city), Bank Y offers credit card Z which best meets your requirements.” This result may be a live result, i.e., displayed directly after a query, or may be tracked by the system over time in order to identify when a more applicable product becomes available. Tracking products over time is advantageous in that it allows the system to notify the user if changes occur to the product, such as a change in interest rate, for instance. If no further narrowing is needed, the process ends at step 222.

In at least one respect, example embodiments may be a “topical” or vertical search engine which operates on a set of pre-defined dam structures representing a product or service offered by a provider or player within an industry. For example, a data structure can be the generic or ontological attributes of a credit card and the institution offering the product. By taking into account the profile date of the user, and/or by being directed by the user's interaction with the example search engine, the system recommends a best-fit product that meets the user's requirements.

### Example Search

The following description and referenced figures provides an example of data location utilizing an example embodiment of the present invention. The chosen example product is a credit card, which advantageously provides a complex scenario, which illustrates the various considerations when determining a product's ranking and illustrates how a user would work with the presented information. A credit card is just one example of a search topic and many additional search topics exist within all other industries, such as real estate, investments, telecommunications, healthcare, and many others.

FIG. 3 illustrates one example of a page body layout 300 for interaction with an embodiment of the present invention. The page layout 300 is divided into several sections, the first being a search criteria entry/selection section 302, the second being a results area 312, and the third section 314 allowing the user to see where his/her own or potential card ranks on the scale that selected the best card. It should be noted that the selections shown in the figure are merely exemplary and are not exhaustive of all possible search criteria. In the particular example shown, users can start their search by defining their location in field 303. This definition can be a hierarchical set of choices including, for instance, Country, State, County, City, or the location can be pre-populated if this data has been submitted before either for this product or in any other prior sessions, for any reason. If this is the first interaction with the site and no other location data exists, IP address positioning will be used to refine the location to as low a level as possible.

Field 304 presents a list of fixed variables for the desired type of credit card. The ranking system of an example embodiment of the present invention is able to rank all cards of the same type. A few exemplary ranking fields are: All Credit Cards, Regular Credit Cards, Secured Cards, Rewards Card—Air Travel, Rewards Card, Gift/Merchandise, and others.

There is also, in this example, a field 306 that provides help, describes the current selection, and/or provides interaction tips. The field 306 can change depending on the selection made in field 304. The description field 306 provides support to the user and helps the user make the correct selection.

A clickable link is provided in field 308 that selects the ranking method of the example embodiment of the present invention. Embodiments of the present invention rank products in a standard three-step process if no selection is made. First, it assigns a score to each attribute of every card, rating its comparison to other cards in the same category of cards, e.g., Rewards Cards. Second, the scores are assigned a weight based upon how relevant each attribute is to the individual user and then the scores are re-scored. Lastly, the scores of each attribute are tallied and, in this example, the cards are scored against each other, with the overall highest score ranked #1.

For the system to gain the importance rating of each attribute, there are three levels of complexity: system default ratings, preset scaled ratings, and in-depth custom ratings. This ranking system applies to all products and will be explained in further detail below. If a user changes from the default ranking system, to some other ranking system, a message appears in field 310 indicated this change.

### Location Refinement

By refining their location, the users are able to have direct access to products in their geographical region. Although in the credit card example, this is rarely used, as the vast majority of cards are available nationally. However, there are still a significant number of cards which rely on smaller geographical regions.

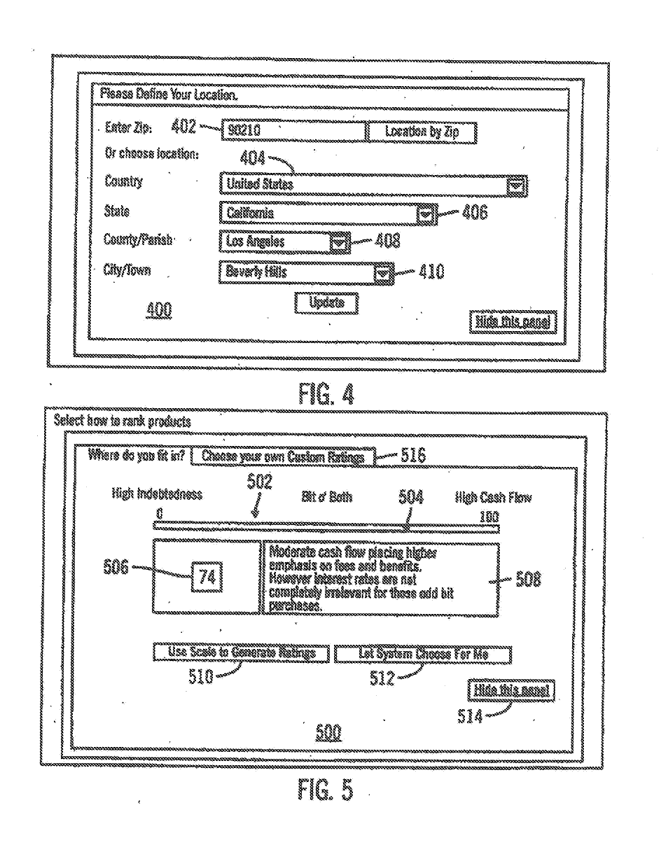

FIG. 4 shows one embodiment of a location-refinement screen that can be used by a user to specify his/her geographic location so that product searches can be narrowed by including these fields. The location screen 400 is reached by selecting the link in field 303 of FIG. 3. The particular location screen 400 shown in FIG. 4 includes an exemplary standard set of geographic entry boxes, such as zip code 402, country 404, state 406, county 408, and city 410. Drop-down boxes or entry boxes can be used to enter geographic data into the system. The screen 400 can vary, based on, for example, information obtained from the user computer's IP address. For instance, in a location such as the United Kingdom, a postal address is entered instead of a zip code.

### Importance Rating

FIG. 5 shows one example of a graphical user interface for setting attributes associated with a user. This screen is reached by selecting the link in field 308 of FIG. 3. By using this panel 500, users can rate, for the credit card example, their own level of indebtedness or cash flow. Example embodiments of the present invention can apply preset importance ratings, depending on the selected scale value, to the attributes of the product. These preset ratings are determined by considering general factors that a person who fits into that position on the scale would and should be looking for in a card.

The scale 502 is structured as a series between two values, for instance 0 and 100. Zero, meaning high indebtedness and 100 meaning high cash flow. Users can drag the scale arrow 504 to find the position which best suites their situation. Value 506 show the position of the arrow in the scale. Although the positions are grouped into preset categories, the selected value still plays a part in the impedance calculation. Field 508 provides a description of the presets category. Once the user has positioned the arrow 504, clicking button 510 will indicate to the system that the scale value 506 should be used as an input for the ranking function. As an alternative, the user can select system defaults by clicking the “Let System Choose For Me” button 512. If no changes are desired, the panel 500 can be hidden by clicking button 514. By clicking on the tab 516 at the top of the screen, users can pull up a screen that allows them to enter custom ratings.

### Custom Ratings

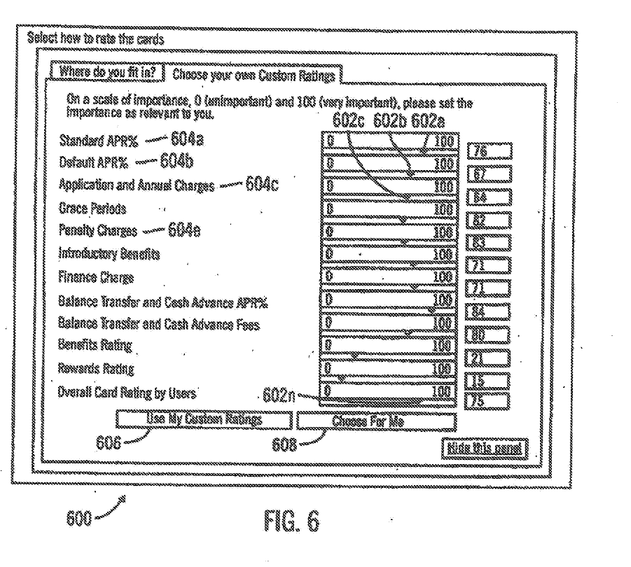

FIG. 6 shows a graphical user interface that appears when a user selects the tab 516 of FIG. 5. The resulting screen 600 allows a user to input further detailed attributes into the system. In this example, the attributes are importance rating settings. Users can choose between the scale rating as discussed above and shown in FIG. 5, or the custom ratings shown here.

The custom ratings are selected by moving a slider bar 602a-n for each corresponding attribute group 604a-n. The slider groups 604a-n shown in FIG. 6 may not always be the attributes themselves, but can be low-level groupings of the attributes to allow for a more fine-tuned view. For example, the attribute group Penalty Charges 604c applies to the attributes—“late payment fee” and “over the limit” fee. This section is useful for users with a good knowledge of cards.

At the bottom of the screen is two buttons. The first button 606 indicates to the system that the attributes are satisfactorily set and that they should be used to conduct a customized search. The second button 608 tells the system to use system default values to conduct the search. In one embodiment, default data is combined with available profile data and used as inputs for the ranking function. It should be noted that the screens shown in the figures and described here are merely exemplary and that the invention is not limited in any way to what is shown in the figures or described in these examples.

### Results

FIG. 7 shows the results of a search performed using the attributes selected in the previous figures and described above. The result screen 312 is typically displayed as soon as a search is activated and returns a result. The result screen 312 has a text field 702 that states, in appropriate circumstances, which product is best given a particular location. With credit cards, this usually displays as a single line item. However, in instances where the #1 product is not available in a user's location, but is in a broader region, two line items will appear. For example, one line item will detail the best product in the country, and the second line item will be the best product in the state, city, and town. This allows the user a broader view beyond their state.

Field 704 shows the ranking of the product compared to all other returned products in the particular search. Field 706 shows an image of the product (if available); otherwise a “no preview” image appears. In the next field 708, the name of the product, in this case, credit card and the institution providing the card, is shown. Field 710 provides a summary of key points the card has to offer. One advantage of embodiments of the present invention is that the jargon is reduced. The user can interact with the system further to get additional attributes of the product if he/she desires.

In one embodiment of the present invention, a user star-ranking system is implemented. The user-star ranking 712 is a custom satisfaction rating which is collected from users and/or retrieved from consumer watchdog websites. The ranking system scores the attributes of the product and weighs the importance of each as applicable to the user. It has the ability to combine quantitative data as well as qualitative data in order to generate a ranking. In the event the example system is unable to collect data for a product, an overall rating for an institution can be factored into its product rating. Ratings are determined by the overall average score for the product; however weightings can vary between the various data sources. For example, ratings collected through example embodiments of the present invention can have a weighting of 1, whereas ratings from less-reputable sites will have a rating of 0.8.

Although the consumer rating of the card is displayed separately, it is still used as part of the ranking function as an attribute. It is also possible that the consumer rating will be featured as a tie-breaker amongst rankings.

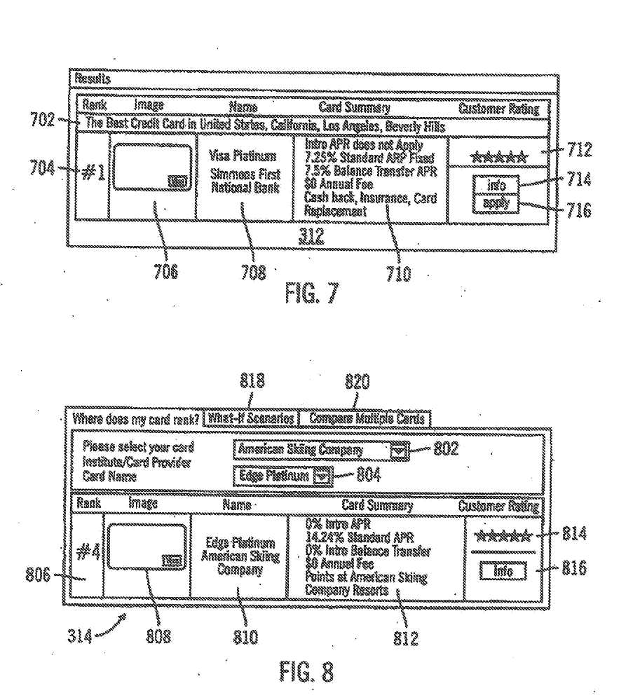

The results screen 312 of FIG. 7 also features an “Info” button 714. By clicking the Info button 714, a user can cause a panel to display that will list the individual attributes of the card as compared to all other cards selected on the page. This comparison is shown, for instance, in FIG. 8, which is explained below.

As an additionally advantageous feature, for the credit card application, and for other similar products, an “Apply” button 716 is provided on the results page 312. The Apply button 716, used in conjunction with an online application facility, allows the user to apply for the product online. This function can direct the user to a product provider's web page or can call up an information submission screen(s), which can be used to collect information and then forward the information to a product provider's business, either electronically or in tangible form.

### Further User Interaction

In one embodiment, the user is able to select, through use of field 314 (in graphical user interlace 300 shown in FIG 3), their existing credit card and find out where it ranks on the scale which led to the selection of card #1 being found. It also gives hypothetical expenditure examples, for instance, if a user were purchasing on one card as opposed to another. Section 314 is shown in greater detail in FIG 8.

Selecting a product can be performed by first selecting, on a first tab 817, through an input field 802, the provider and then narrowing down, through another input field 804, to the individual product. The user's choice of product, in this case a credit card, is displayed in fields 806-816. Field 806 shows the card's ranking against other cards in its class. Fields 808 and 810 show product identification text and, if available, an image of the product. Field 812 provides a summary of the card's attributes. A consumer rating of the card is shown in field 814. By selecting the Info button 816, a screen can be reached, which shows more detailed attributes of the card.

In one embodiment, what-if scenarios are available and allow a user to convert the card attributes into dollar terms based on the user's scenario. What-if scenarios can be entered by clicking on tab 818. These scenarios can be a powerful tool for the user, as it allows him/her to actually simulate different financial situations. If an example embodiment of the invention were used, for instance, with mutual funds, it would allow the user to enter different scenarios pertinent to mutual funds, such as varying interest rates, terms, tax rates, etc.

A third available tab 820 allows the user to select a comparison of multiple credit cards. In this function, selected cards are compared attribute by attribute in a detailed table. Further information can be provided to the user by either furnishing contact details to the provider or sending a request to the provider for product brochures and other information.

### Interaction Summary

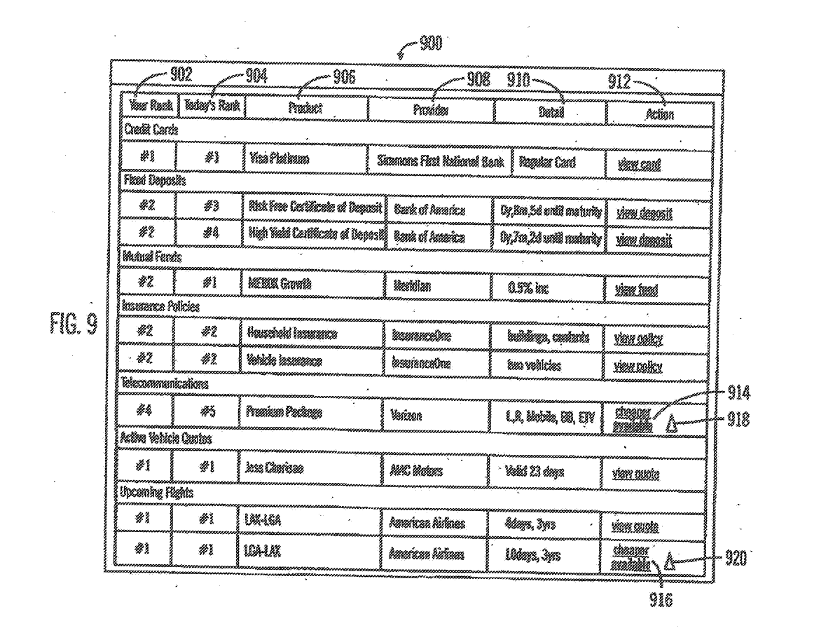

FIG. 9 shows an interaction summary page 900. The interaction summary page 900 allows registered users to gain a “bird's-eye” view of all their flagged interactions with the example embodiment of the present invention. At a glance, the user will be able to determine the status of their investments, facilities, policies, purchases, etc. within the general marketplace as a whole. As an additional feature, the example embodiment of the present invention provides an alerting system, which flags the user as to new developments within their products.

The interaction summary page 900 can form a part of a landing page for registered users, and be available through various web feed formats, such as RSS. RSS is used to publish frequently updated content such as blog entries, news headlines, or podcasts. An RSS document, which is called a “deed,” “web feed,” or “channel,” contains either a summary of content from an associated web site or the full text. RSS makes it possible for people to keep up with their favorite web sites in an automated manner that is easier than checking them manually. Users have the ability to use their own web aggregators running on either their desktop or web blogs to pull this summary 900 down and gain a perspective of their affairs without having to go through the arduous process of navigating to the website and logging in. All further interactions can, therefore, be conducted on the website.

FIG. 9 shows several columns 902-912 containing exemplary fields that can appear in the summary page 900. For example, column 902 contains the rank of each product at the tune the user added it to the summary and column 904 contains fields that show the rank of the product as it applies at the time the summary was downloaded. The importance ratings are stored in the users profile and are retrieved when determining that day's ranking. Column 906 shows the product name and column 908 lists the provider of the product. Column 910, in this example, shows important information about the status of each product. In the summary screen 900 of FIG. 9, a link to other portions of the example embodiment of the present invention is provided in column 912 to allow for further interaction with the product.

The marketplace is an evolving entity. Decisions that are made today are not necessarily the best tomorrow. The example embodiment of the present invention assists users in making decisions which are ongoing and continually relevant. This is achieved by continually searching for the “better deal” based on the user's requirements. If the system is able to recommend a more appropriate service provider or product, the user is notified via a predefined communication channel. For instance, as is shown in two of the fields, 914 and 916, of column 912, a warning indicator 918 and 920, respectively, appears when conditions specified by the user are met. These warnings include an early and a late warning. The late notifier notifies a user if a letter rate or price becomes available. The early notifier notifies the user of upcoming product events or requirements, e.g., when funds are near their maturity date.

### Server

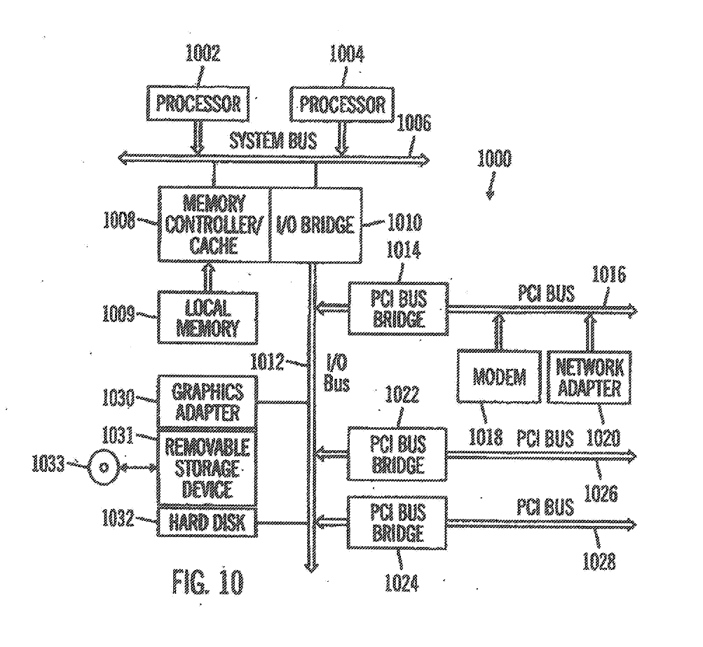

Referring to FIG. 10. a block diagram of a data processing system that may be implemented as a server, such as server 106 and/or server 110 in FIG. 1, is depicted in accordance with one embodiment of the present invention. Data processing system 1000 may be a symmetric multiprocessor (SMP) system including a plurality of processors 1002 and 1004 connected to system bus 1006. Alternatively, a single processor system may be employed. Also, connected to system bus 1000 is memory controller/cache 1008, which provides an interface to local memory 1009. I/O bus bridge 1010 is connected to system bus 1006 and provides an interface to I/O bus 1012. Memory controller/cache 1008 and I/O bus bridge 1010 may be integrated as depicted. The processor 1002 or 1004 in conjunction with memory controller 1008 controls what data is stored in memory 1009. The processor 1002 or 1004 can also work in conjunction with any other memory device or storage locations, such as storage areas 108a-n, to serve as a monitor for monitoring data being stored and/or accessed on the data storage areas 108a-n.

Peripheral component interconnect (PCI) bus bridge 1014 connected to I/O bus 1012 provides an interface to PCI local bus 1016. A number of modems may be connected to PCI bus 1016. Typical PCI bus implementations will support four PCI expansion slots or add-in connectors. Communications links to network computers 104a-n in FIG. 1 may be provided through modem 1018 and network adapter 1020 connected to PCI local bus 1016 through add-in boards.

Additional PCI bus bridges 1022 and 1024 provide interfaces for additional PCI buses 1026 and 1028, from which additional modems or network adapters may be supported. In this manner, data processing system 1000 allows connections to multiple network computers. A memory-mapped graphics adapter 1030 and hard disk 1032 may also be connected to I/O bus 1012 as depicted, either directly or indirectly.

Those of ordinary skill in the art will appreciate that the hardware depicted in FIG. 10 may vary. For example, other peripheral devices, such as optical disk drives and the like, also may be used in addition to or in place of the hardware depicted. The depleted example is not meant to imply architectural limitations with respect to the present invention.

In this document, the terms “computer program medium,” “computer usable medium,” and “computer readable medium” are used to generally refer to media such as main memory 1009, removable storage drive 1031, removable media 1033, hard disk 1032, and signals. These computer program products are measures for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may include computer readable information in a transitory state medium such as a network link and/or a network interface, including a wired network or a wireless network, that allow a computer to read such computer readable information.

Computer programs (also called computer control logic) are stored in memory. Computer programs may also be received via communications interface 1016. Such computer programs, when executed, enable the computer system to perform the features of the example embodiments of the present invention as discussed herein. In particular, the computer programs, when executed, enable the processor 1002 and/or 1004 to perform the features of the computer system. Accordingly, such computer programs represent controllers of the computer system.

### Client Device

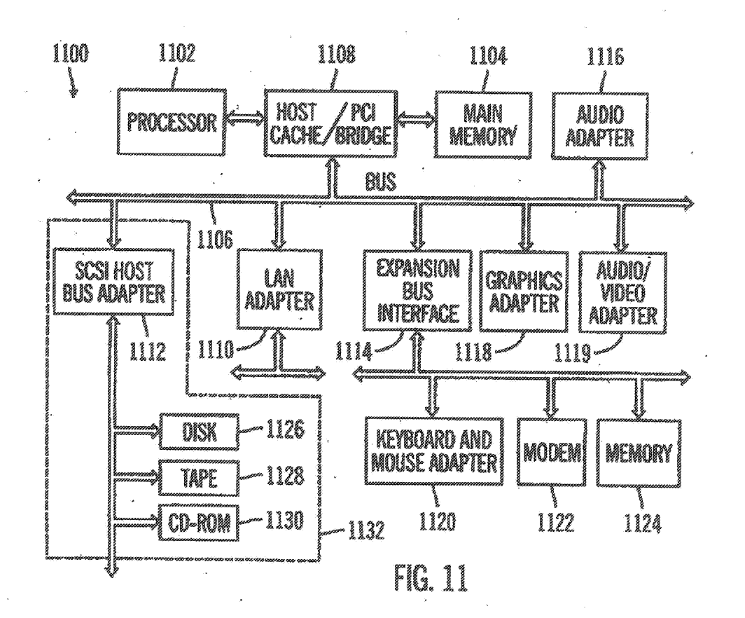

With reference now to FIG. 11, a block diagram illustrating a data processing system is depicted in which example embodiments of the present invention may be implemented. Data processing system 1100 is an example of a client computer 104. Data processing system 1100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 1102 and main memory 1104 are connected to PCI local bus 1106 through PCI bridge 1108. PCI bridge 1108 also may include an integrated memory controller and cache memory for processor 1102. Additional connections to PCI local bus 1106 may be made through direct component interconnection or through add-in boards. In the depicted example, local area network (LAN) adapter 1110, SCSI host bus adapter 1112, and expansion bus interface 1114 are connected to PCI local bus 1106 by direct component connection. In contrast, audio adapter 1116, graphics adapter 1118, and audio/video adapter 1119 are connected to PCI local bus 1106 by add-in boards inserted into expansion slots. Expansion bus interface 1114 provides a connection for a keyboard and mouse adapter 1120, modem 1122, and additional memory 1124, for example. Small computer system interface (SCSI) host bus adapter 1112 provides a connection for hard disk drive 1126, tape drive 1128, and CD-ROM drive 1130, for example. Typical PCI local bus implementations will support three or four PCI expansion slots or add-in connectors.

An operating system runs on processor 1102 and is used to coordinate and provide control of various components within data processing system 1100 in FIG. 11. Each client is able to execute a different operating system. The operating system may be a commercially available operating system, such as WINDOWS XP®, which is available from Microsoft Corporation. A database program such as ORACLE® may run in conjunction with the operating system and provide calls to the operating system from JAVA® programs or applications executing on data processing system 1100. Instructions for the operating system, the object-oriented operating system, and applications or programs are located on storage devices, such as hard disk drive 1126, and may be loaded into main memory 1104 for execution by processor 1102.

Those of ordinary skill in the art will appreciate that the hardware in FIG. 11 may vary depending on the implementation. Other internal hardware or peripheral devices, such as flash ROM (or equivalent nonvolatile memory) or optical disk drives and the like, may be used in addition to or in place of the hardware depicted in FIG. 11. Also, the processes of example embodiments of the present invention may be applied to a multiprocessor data processing system.

As another example, data processing system 1100 may be a stand-alone system configured to be bootable without relying on some type of network communication interface, whether or not data processing system 1100 includes some type of network communication interface. As a further example, data processing system 1100 may be a Personal Digital Assistant (PDA) device, which is configured with ROM and/or flash ROM in order to provide non-volatile memory for storing operating system files and/or user-generated data.

The depicted example in FIG. 11 and above-described examples are not meant to imply architectural limitations. For example, data processing system 1100 also may be a notebook computer or hand-held computer in addition to taking the form of a PDA. Data processing system 1100 also may be a kiosk or a Web appliance.

### Mutual Funds

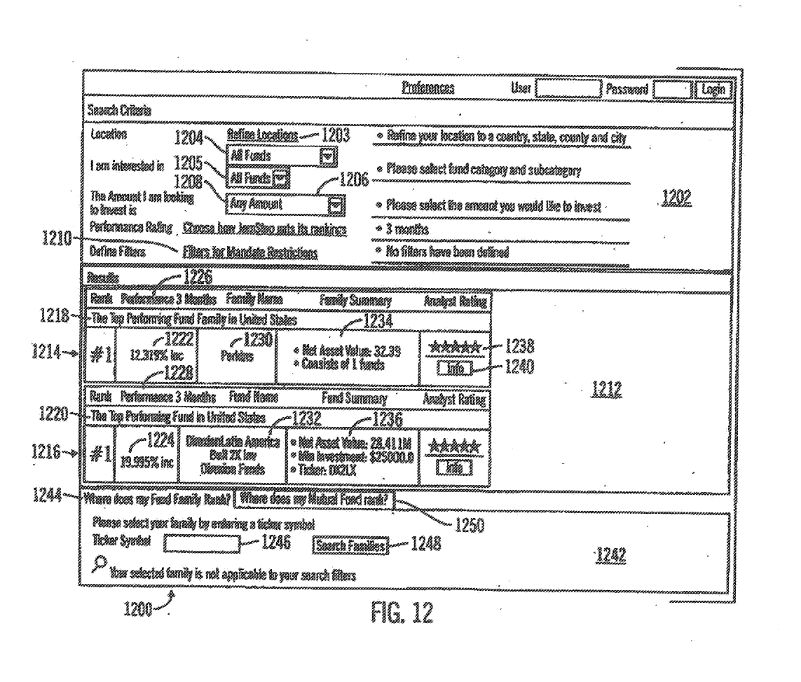

FIGS. 12-16 show another non-limiting example of a use for example embodiments of the present invention. The particular example shown in FIGS. 12-16 is related to mutual funds. FIG. 12 illustrates one example of a page body layout 1200 for interaction with an example embodiment of the present invention. The page layout 1200 is divided into several sections, the first being a search criteria entry/selection section 1202, the second being a results area 1212, and the third section 1242 allowing the user to see where his/her own or potential mutual fund or family of funds rank on the scale that selected the best fund or family of funds. It should be noted that the selections shown in the figure are merely exemplary and are not exhaustive of all possible search criteria. In the particular example shown, users can start their search by defining their location in field 1203. This definition can be a hierarchical set of choices including, for instance, Country, State, County, City, or the location can be pre-populated if this data has been submitted before either for this product or in any other prior sessions, for any reason. If this is the first interaction with the site and no other location data exists, IP address positioning will be used to refine the location to as low a level as possible.

Fields 1204 and 1205 present lists of fixed variables for the desired type of fund. Field 1204 is a category and field 1205 is a subcategory of the family and fund. In one embodiment, the drop down choices for the category 1204 consist of: Bond Funds, Hybrid Funds, International Stock funds, and U.S. Stock funds. The subcategories in drop down box 1205 include, for example, Large Blend and Large Growth funds.

Field 1206 allows a user to specify the amount that they wish to invest. This field can be used to filter funds by their required initial investment amount, or that use an investment amount as a criteria for some factor related to the fund.

A clickable link is provided in field 1208 that selects the ranking method of the example embodiment of the present invention. Embodiments of the present invention rank products in a standard three-step process if no selection is made. First, it assigns a score to each attribute of every fund (or whatever product is the subject of the search), rating its comparison to other funds in the same category of funds. Second, the scores are assigned a weight based upon how relevant each attribute is to the individual user and then the scores are re-scored. Lastly, the scores of each attribute are tallied and, in this example, the funds are scored against each other, with the overall highest score ranked #1.

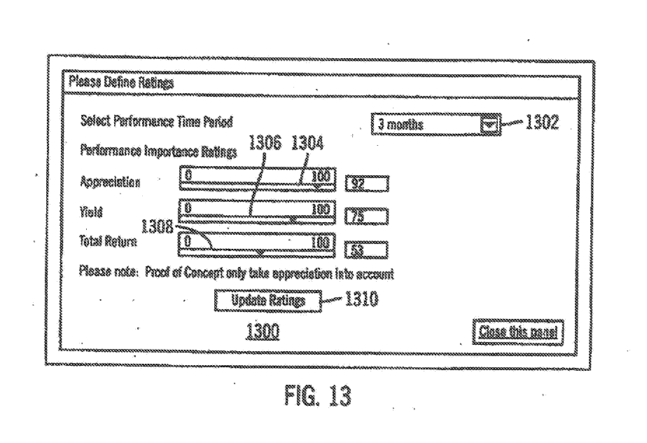

For the system to gain the importance rating of each attribute, there are three levels of complexity: system default ratings, preset scaled ratings, and in-depth custom ratings. This ranking system applies to all products. FIG. 13 shows a graphical user interface screen 1300 that appears once a user clicks on the link 1208. Similar to the credit card example, this screen dictates how the example embodiment of the present invention will rate the funds under consideration.

The first selectable field of FIG. 13 is field 1302, which defines the time period for consideration. The example embodiment of the invention will track a fund or family of funds over the period selected to determine a yield or other attribute. The following 3 fields, 1304, 1306, and 1308, are exemplary attributes of a mutual fund that might be useful in comparing two or more funds. The first field 1304 has a slider for selecting an importance rating for the attribute of appreciation. The second field 1306 has a slider for selecting an importance rating for the attribute of yield. The third field 1308 has a slider for selecting an importance rating for the attribute of total return. After setting the importance ratings of one or more of the fields, their values are input to the system by clicking on the “update ratings” button 1310 at the bottom of the screen 1300.

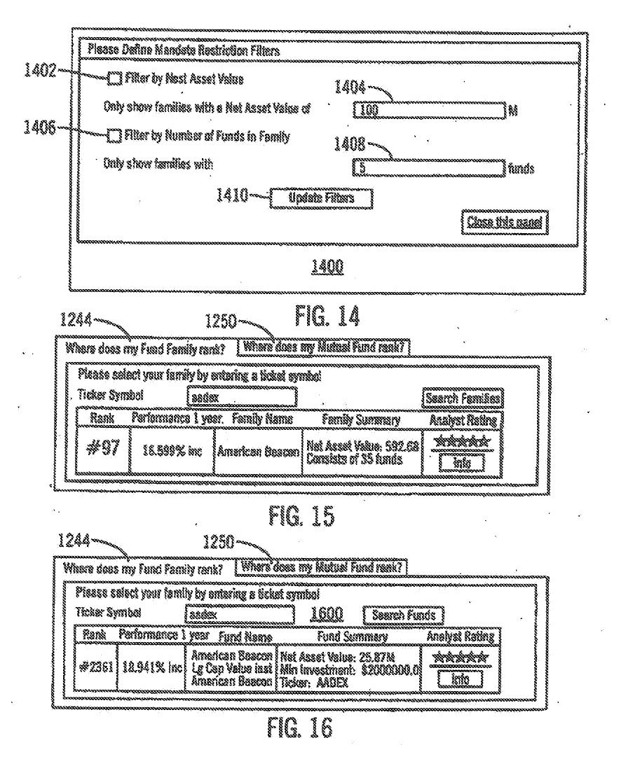

Returning back to FIG. 12, field 1210 is a clickable link to determine how the example embodiment of the present invention filters the funds. An exemplary graphical user interface 1400 that would appear after a user clicks link 1210 is shown in FIG. 14. This screen 1400 can be used by, for example, investors who have to invest as per a mandate established by their investing organization. The screen 1400 has a checkbox 1402 that indicates to the system that the user wishes to filter the families by the total net asset value of the family. If this checkbox 1402 is checked, the system will use the value in that user entry field 1404, which indicates to the system the net asset value by which to filter funds. A second checkbox 1406 indicates to the system that the user wishes to filter families of funds by how many funds each family of funds possesses. If this checkbox 1406 is checked, the system will filter based on the number of funds indicated in box 1408. A button 1410, upon being clicked, updates the filters and refreshes the rankings.

The next main section 1212 of FIG. 12 shows the number one family of funds 1214 and the number one fund 1216. The results shown in fields 1214 and 1216 are typically displayed as soon as a search is activated and returns a result. Each of the fields 1214 and 1216 have a text field 1218 and 1220, respectively, that states, in appropriate circumstances, which product is best given a particular location.

In the next fields, 1222 and 1224, a fund family's performance and a fund's performance, respectively, over a period of time, is shown. This period of time is identified in the header 1226 and 1228 above the fields 1222 and 1224, respectively. An identifier of the fund family and family of funds is shown in fields 1230 and 1232, respectively. Fields 1234 and 1236 provide a summary of key aspects of the number one ranked fund family and fund, respectively. These number one ranked products may preferably conform to the location information entered into field 1203. One advantage of the example embodiment of the present invention is that the jargon is reduced. The user can interact with the system further to get additional attributes of the product if he/she desires.

In one embodiment of the present invention, an analyst star-ranking system is implemented. The analyst star-ranking 1238 is a custom satisfaction rating which is collected from analyst and/or retrieved from other information sources. The ranking system scores the attributes of the product. It has the ability to combine quantitative data as well as qualitative data in order to generate a ranking. In the event the example system is unable to collect data for a product, an overall rating for an institution can be factored into its product rating. Ratings are determined by the overall average score for the product; however weightings can vary between the various data sources. For example, ratings collected through the example embodiment of the present invention can have a weighting of 1, whereas ratings from less-reputable sites will have a rating of 0.8. Although the analyst rating of the fund is displayed separately, it can still used as part of the ranking function as an attribute. It is also possible that the analyst rating will be featured as a tie-breaker amongst rankings.

The results field 1212 also features an “Info” button 1240. By clicking the Info button 1240, a user can cause a panel to display that will list the individual attributes of the fund as compared to all other funds selected on the page.

Ranking field 1242 provides two tabs. The first tab 1244, when selected, allows a user to enter a fund family identifying code in the field 1246. This section ranks the user's family which he/she has invested in. These rankings are continually updated when the user changes the filter or scale requirements. This is so the user has a view of his own fund ranking as it arises within the changing criteria. Upon depressing a button 1248, a screen similar to the one shown in FIG. 15 is shown to the user.

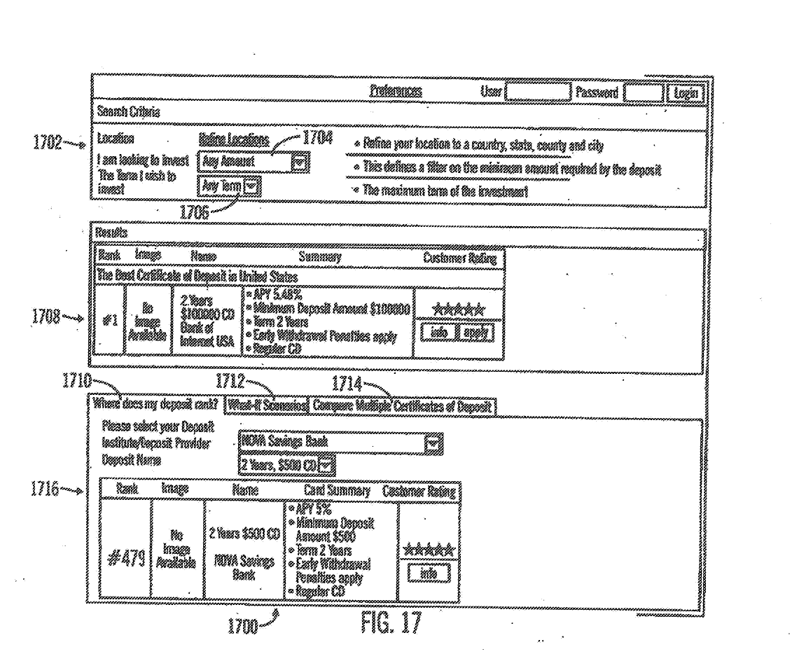

A second tab 1250 brings up a screen similar to screen 1600 shown in FIG. 16. Screen 1600 allows users to see the individual funds performance. Further interaction in this section will allow the user to track the performance of the fund over time at set intervals. The performance can be presented with a ranking, as well as the percentage change.

### Certificates of Deposit

FIG. 17 shows another exemplary use of example embodiments of the present invention, which is to analyze certificates of deposit (CDs). The screen 1700 is similar to those examples described above and shown in the figures. FIG. 17 has a first field 1702 for inputting CD criteria, such as amount to invest 1704 and investment term 1706. The screen 1700 has a results section 1708 for presenting the number 1 CD and a ranking and comparing section 1716. The ranking and comparing section 1716 has a first tab 1710 that, when selected, allows a user to rank a particular CD against all others in a comparison group. A second tab 1712 allows the user to engage in what-if scenarios. Finally, a third tab 1714 allows a user to compare multiple CDs against each other.

The graphical user interface 1700 shown in FIG. 17 is not meant to be limiting. The present invention is not necessarily required to have all of the features shown and may also have additional features.

### Example Embodiment Using Product Ontology, Expert System and Ranking Engine

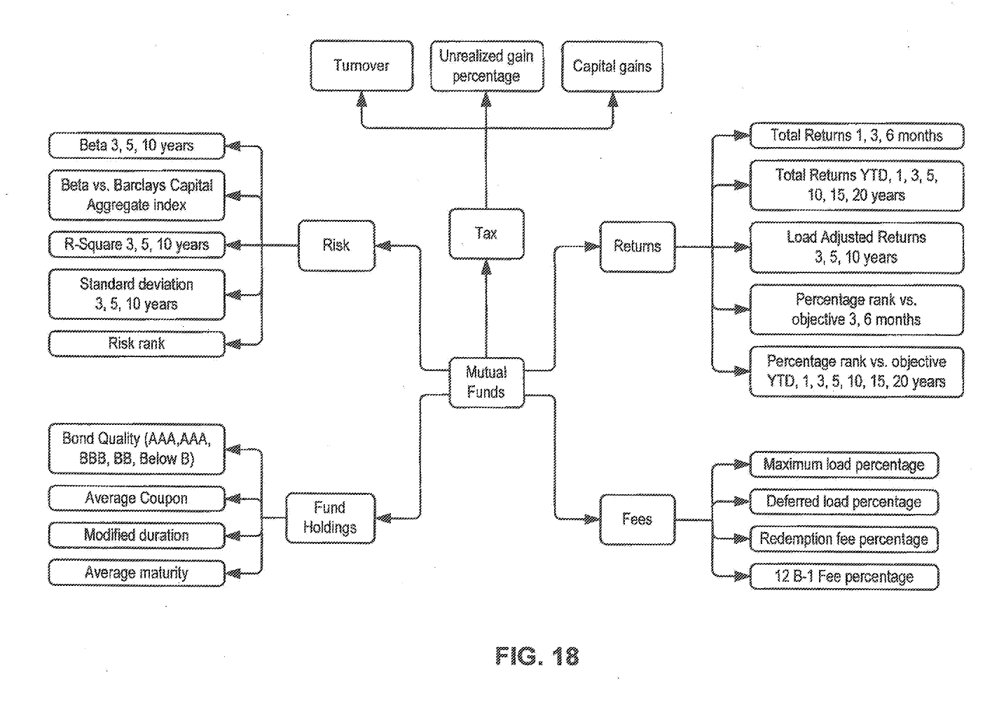

Example embodiments using a product ontology, expert system and ranking engine will now be described in connection with FIGS. 18-24. The comparison between multiple entities, and furthermore, evaluating how relevant those comparisons are to the evaluator is fundamental in the human decision making process. The effectiveness of human decision making is inversely proportional to the complexity of the comparison at hand. One example of this situation is in the evaluation of complex day-to-day investments, products and services (collectively called products). Example embodiments of the present invention described below may assist the evaluator by:
presenting the complexity of a decision in a manageable way;
allowing the objective comparison between multi-factor entities;
educating the user in the problem space;
ranking all products and services within the problem space as to how best they match the users requirements;
delivering rankings which are personal to the user, and could possibly have no bearing on other users;
making the ranking process transparent;
allowing the user to compare all products within the problem space;
allowing for a sophisticated decision making process regardless of the user's level of expertise within the problem space.

### Product Ontology

In an example embodiment, the system and methodology may be organized around an ontological structure for the product. Decomposing the product into the underlying attributes and their relationships results in a structure which defines the product domain. Products within the same domain may be rank-able. The depth or level of detail of the ontology can affect the rank-ability of products even though they fall within the same “stable” of products. An example of this is the ranking of mutual funds. At a high level (less detailed ontology), mutual funds can be ranked on risk, performance, fees and tax implications. Taking a finer-grained view of the ontology and decomposing the funds into asset class specific attributes (such as quality and maturity in the case of bond funds, and market cap and investment style in the case of stock funds) results in a different ontological structure or product domain.

Decomposing a product into an ontological structure starts with identifying the attributes of the product and organizing those attributes into attribute groups having common types or concepts. Attributes may be both qualitative and quantitative in nature. If qualitative, an arbitrary, attribute specific scoring method may be applied in order to transform it into a tangible quantitative attribute. An example of this method is the use of a 5 point system to rate the reward type associated with a credit card. An example of an attribute group in the case of mutual funds would be performance. The attributes that make up performance are 3 year performance, 5 year performance and 10 year performance, etc.

FIG. 18 is a block diagram illustrating an example product ontology for mutual fund products according to an example embodiment. At a top level, the ontology includes the following attribute groups: risk, tax, returns, fund holdings and fees. In each group, there are a number of individual attributes for the product that can be used for evaluating and ranking the products. For example, the attribute group “risk” includes attributes for Beta for 3, 5 and 10 years. Beta vs. Barclays Capital Aggregate Index, R-Square for 3, 5 and 10 years, Standard deviation for 3, 5 and 10 years, and Risk Rank. The attribute group “Fund Holdings” in this example includes Bond Quality, Average Coupon, Modified duration and Average maturity. The attribute group “Tax” in this example includes Turnover, Unrealized gain percentage and Capital gains. The attribute group “Returns” in this example includes Total Returns for 1, 3 and 6 months, Total Returns YTD for 1, 3, 5, 10, 15 and 20 years, Load Adjusted Returns for 3, 5 and 10 years, Percentage vs. objective for 3 and 6 months, and Percentage rank vs. objective YTD for 1, 3, 5, 10, 15 and 20 years. The attribute group “Fees” in this example includes Maximum load percentage, Deferred load percentage, Redemption fee percentage and 12 B-1 Fee percentage. These are examples only and different embodiments may use different attribute groups and product attributes.

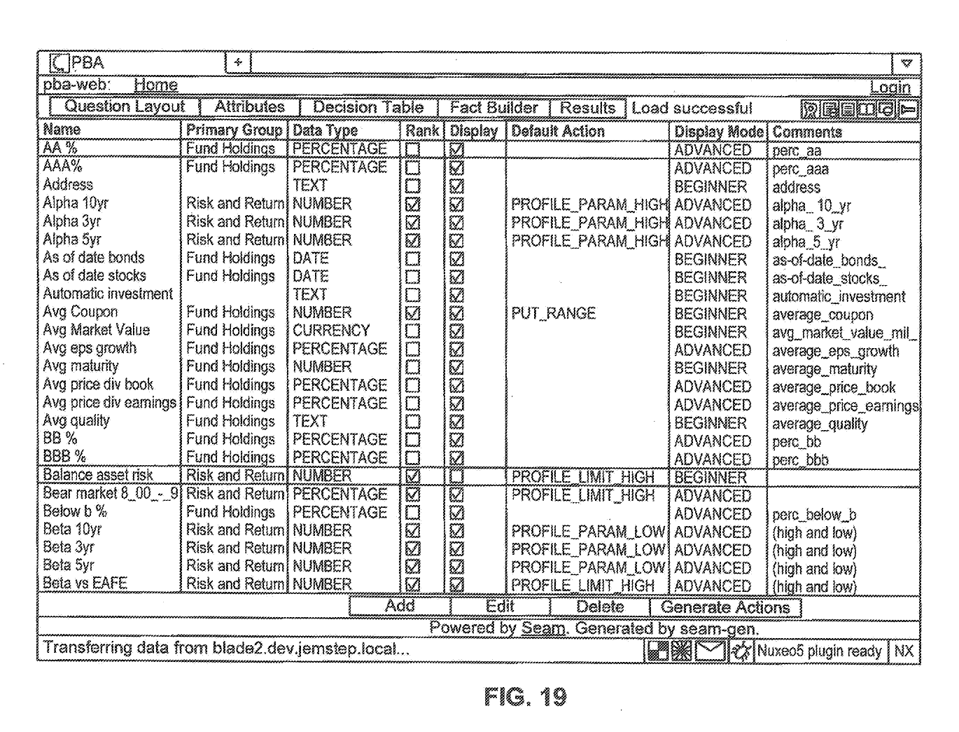

FIG. 19 is an example table illustrating product attributes and attribute groups for mutual fund products according to another example embodiment. The first column in FIG. 19 lists attributes by their attribute names. The second column lists the attribute group for each attribute. For example, as shown in FIG. 19, attributes “Alpha 10 yr”, “Alpha 3 yr” and “Alpha 5 yr” are in the attribute group “Risk and Return”. The third column lists the data type for the attribute. The fourth column indicates whether the attribute is used for ranking products. The fifth column indicates whether the attribute is displayed to the user. The sixth column includes a default action for the attribute that is used unless the user's input determines a different action to be taken for the attribute. The seventh column indicates the display mode, which is used to determine whether to display the attribute in beginner made or only in advanced mode. These are examples only and different embodiments may use different product attributes, attribute groups and attribute properties.

By organizing individual products into attribute groups, example embodiments may abstract away from the complexity presented by all of the individual attributes that can be used for evaluation and ranking. In example embodiments, the system may operate in a number of different modes, such as a beginner mode, advanced mode and expert mode. In a beginner mode, the user may be asked a series of high level profiling questions corresponding to each attribute group. Rules may be defined that adjust the weighting of individual attributes within the attribute group based on the answers to the questions. In this way, a beginner user may express preferences based on a more general concept without a detailed knowledge of all of the individual attributes that are available for a product. For instance, a beginner user may be asked to provide a general indication of the user's risk/return profile using a sliding scale. From this response, rules from an expert system may be used to adjust weightings to the underlying attributes within the attribute group “Risk and Return” such as the weighting adjustments to be used for the attributes for 3, 5 and 10 year alpha for an investment product.

In another mode of operation, such as an advanced mode, the system may ask more detailed questions tied more directly to more detailed attribute groups or individual attributes. In some embodiments, the ontology may be hierarchical. A small number of top level attribute groups may be defined and questions corresponding to those groups may be asked to beginner users. A larger number of second level attribute groups may also be defined and questions corresponding to this group may be asked to advanced users. An expert mode may also be provided that allows the user to weight each of the individual product attributes. In this way, the level of detail presented to the user can be adjusted based on the mode of operation, even though a large number of individual product attribute can be used for ranking in each mode. The rules from the expert system define how the user's answers and/or weightings for attribute groups are mapped into weightings for the individual product attributes that are used for ranking.

In some embodiments, the system may allow the user to change the mode of operation for each attribute group. For example, a user may use beginner mode to answer questions about the attribute group “investment time horizon”, but may choose to provide preferences for the attribute group “risk and return” in expert mode where a weighting is provided for each individual product attribute. For example, the user may simply indicate that the user is a long term investor for purpose of “investment time horizon”, but may enter individual weightings for attributes within the group “risk and return”, such as providing specific weightings for 1,3 and 5 year alpha and beta attributes for the investment product being evaluated.

The rules for each mode of operation may also limit the allowable range or adjustments to weightings that will be applied to certain attributes or groups depending upon the mode of operation. For example, a user may indicate that the user only cares about returns and does not care about risk. However, the rules defined by the expert system may limit the amount that the weightings are adjusted based on the mode of operation. For example, in beginner mode, the system may not allow the weighting for certain risk attributes to be zero and may require some minimal weighting to be signed to those risk attributes for beginners. Also, the system may balance the overall weighting assigned to an attribute group relative to other attribute groups, so a beginner's answers cannot cause the weighting of one attribute group relative to another attribute group to differ by more than a maximum amount. These outside boundaries and conditions placed on how the user's preferences impact the actual weightings assigned to individual attributes is referred to as “scaffolding”. The amount of scaffolding may be reduced in more advanced modes of operation. In an expert mode, the scaffolding may be eliminated or put under the control of the user, so the user can select any weighting to be used for individual product attributes.

### System Overview

In example embodiments, the system is designed to make use of a classic client/server networking architecture as described in more detail above. In an example embodiment, the system uses a web based architecture with a web-browser based client which invokes rank requests on a remote server. The server-side processing may be done on one server or, alternatively, each application component being designed according to the principles of service orientated architecture may reside on individual servers. In example embodiments, the product attributes and attribute groups are stored in data structures in memory on one or more of the servers. Software is stored in memory and executed on the processors on one or more of the servers. The software includes instructions to carry out the steps of the methods described herein and to access the data in the data structures for such methods. Software executing on the processor(s) implements the rules from the expert system (including scaffolding) to apply weightings to the product attributes based on the user's answers to questions or other input from the user regarding attribute groups or individual attributes. The software executing on the processor then scores the products based on each product's attribute values and the weighting assigned to those attributes and ranks the products as described further below. In an example embodiment, the software includes modules with instructions that cause the processor(s) to carry out these processing steps.

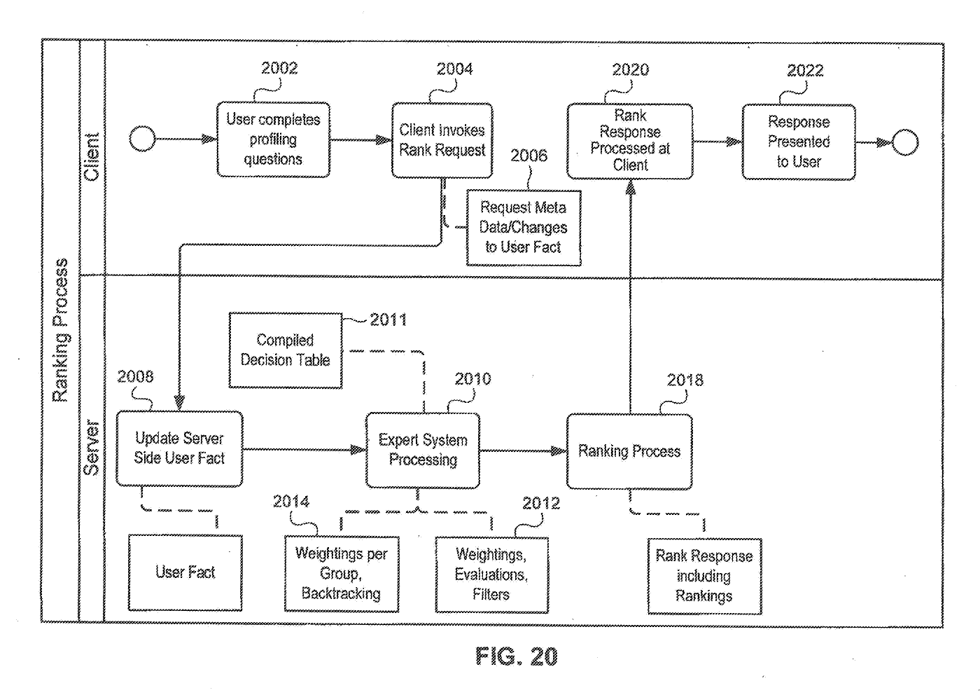

The following is an additional overview description of the steps carried out on a client device and server system according to an example embodiment of the present invention. These steps are illustrated in FIG. 20. The client may select a type of product to be ranked and may set the mode of operation (for example, beginner mode, advanced mode or expert mode). A series of profiling questions are then presented to the user for each attribute group (or for individual attributes) depending upon the mode. As described above, the mode may be changed between different attribute groups so profiling information can be provided at different levels of detail for different groups of attributes. As shown at step 2002 in FIG. 20, the user on the client system completes the profile questions. The user can also provide meta data about the ranking request. For example, the meta data may indicate certain individual products (such as a user's own mutual fund) to be ranked against other products. A data structure referred to as the “User Fact” is used to store the answers to the profiling questions and meta data. As shown at step 2004, the client then invokes the rank request which send the user fact data structure to the server for processing. As shown at step 2006, the rank request is based on the most recent meta data and user responses to profiling questions which are stored in the User Fact data structure.

A corresponding User Fact data structure that is stored in memory on the server is then updated with the most recent information as shown at step 2008. The updated User Fact data structure is then provided to an expert system for processing the rank request as shown at step 2010. The expert system uses decision tables 2011 to determine how to adjust individual product attribute weightings based on the user's answers to the profiling questions. As described above, the profiling questions may relate to a group of attributes and rules based an the decision tables may be used to adjust weightings for individual attributes based on the user's responses. The responses and other user input may also be used to generate filters for filtering the products to be ranked and to adjust the way in which different attributes are evaluated by the system. These weightings, evaluators and filters may be generated and adjusted by the expert system and stored in a data structure in memory on the server for use in the ranking process as shown at 2012. In an example embodiment, the expert system generates a data structure containing the weighting or relative importance of each attribute within the product ontology and how that attribute is to be evaluated. In an example embodiment, the expert system also generates a second data structure which contains the filters to be applied to the product set. The expert system may also generate weightings for each attribute group as shown at step 2014. These group weightings may be used in scaffolding. The system may limit the weightings that can be assigned to a group and to individual attributes in a group based on the mode of operation. This may be determined by placing minimum and/or maximum boundaries on weightings for individual attributes or groups and/or by limiting the amount that the weighting for one group may differ from one or more other groups. The expert system may also generate backtracking information as also shown at step 2014. This is explanatory information for each group and/or attribute that explains how the user's answers impacted the weightings, filters and/or evaluators assigned by the expert system. This can be used to provide transparency to a user and explain how the user's input impacted the ranking process.

In an example embodiment, the server then sends the weightings, filters and request meta data to the ranking engine as shown at step 2018, which processes each product in the data set according to the filters, attribute weightings and request meta data. In an example embodiment, the ranking engine scores and processes each product to deliver a set of products ranked from #1 . . . n, where n is the number of products in the filtered data set. In an example embodiment, the ranking engine also provides ranking meta data which gives users insight into the ranked results. This meta data may also include backtracking information from the expert system to explain how the ranked results were achieved.

In an example embodiment, the server then sends the rank response (which includes the ranking results) to the client for processing as shown at step 2020 and the client displays the results to the user as shown at step 2022. In example embodiments, the rank response may be provided in html, java script or other format that can be displayed by the browser on the client.

### Expert System

The following provides additional description of the functions of the expert system including the input structures, processing and expected output according to an example embodiment. In an example embodiment, the export system is a software module executed on the server as described in connection with FIG. 20.

Input Data Structures. The input data structures used by the expert system in an example embodiment will now be described. In an example embodiment, the expert system receives a “User Fact” data structure and uses “Decision Table” data structures to map the user input in the “User Fact” into weightings, filters and evaluators for individual attributes.

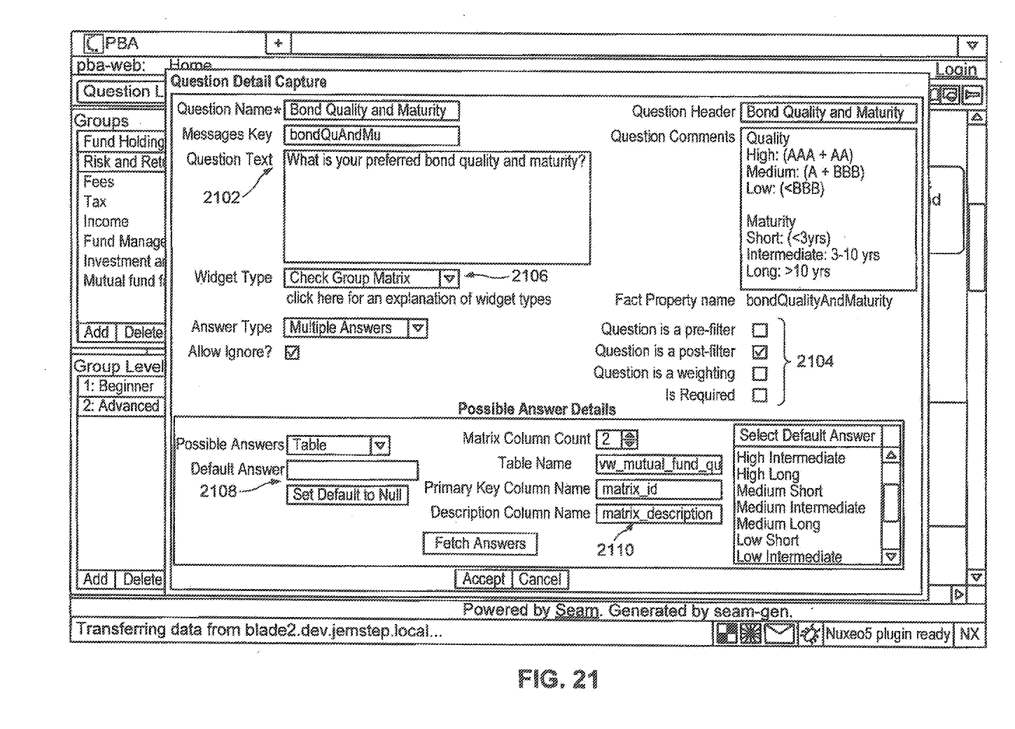

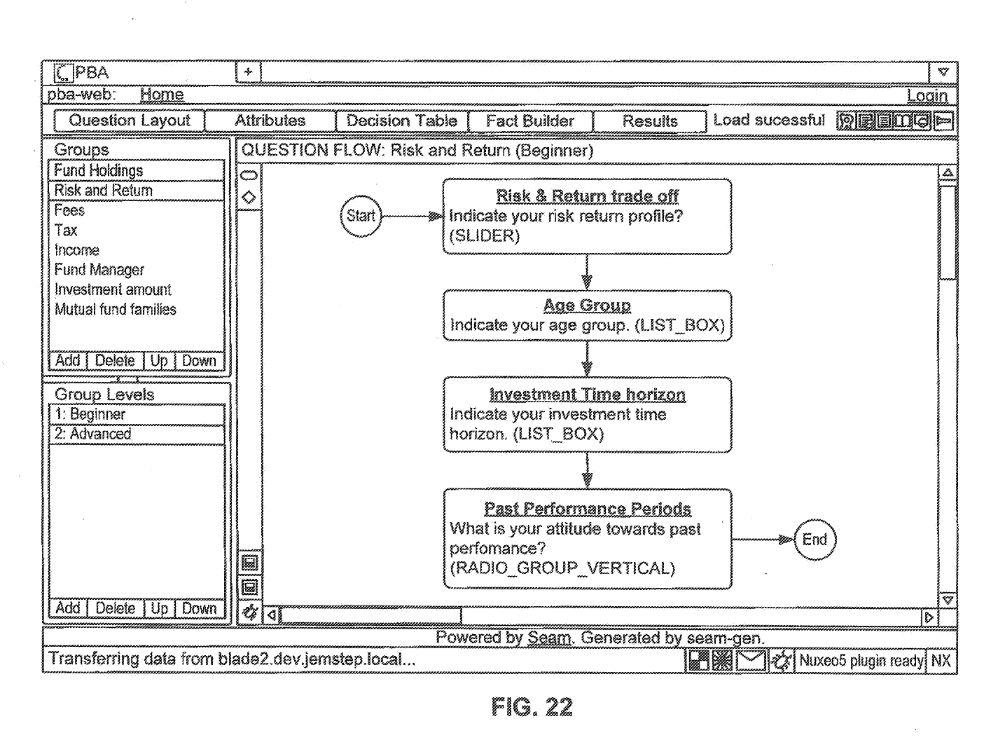

User Fact Data Structure. The User Fact is a data structure with represents the user's answers to the series of profiling questions. In an example embodiment, the fact includes structures for information regarding the “Question Groups and Level of Expertise” and the “Questions and Answers thereof” as further described below:
Question Groups and Level of Expertise. Questions are organized into the same groups as the attribute groups. Each question within a group affects the attributes within the same group. A second organizing factor is the level of expertise required to answer a particular question effectively. The level of expertise is recorded on a per group basis, so that a beginner in group A, may answer questions at a “beginner” level, but may answer questions in group B at an “advanced” level. The group->level relationship is stored within the user fact.
Questions and Answers thereof. Profiling questions, in general, include the following:
   a text string which outlines the problem at hand and prompts the user for a response, e.g. “Group: Fund Holdings, Heading: Mutual Fund Categories, Question: Indicate your preferred mutual fund class: Possible Answers: Stock funds, Bond and Income funds, Balanced funds, All mutual funds”
   a graphical “widget” or “component” into which the user's answer is captured a may consist of a series of possible answers or a specific value.
   a cool tip explaining the users answer e.g. “WHAT DOES “LOW 3 YEAR STANDARD DEVIATION” MEAN? Standard deviation is an estimation of the uncertainty of a mutual fund's future returns by measuring the volatility of the fund's historical returns. It is applied to the fund's annual rate of return for a given period of time. Jemstep offers the standard deviation for 3, 5 and 10 years.”
   a help facility that a user may gain further detail about the question.
Single/Multi-value answers. Depending on the type of question asked, a single value answer may be the result, alternatively a multi-value answer may the result. In the first case, an example is: “How important are previous returns in your rankings?”, in the latter case: “Select which bond qualities you want to rank”. The User fact contains data structures allowing the storage of both cases. FIG. 21 is an example screen display for defining question properties and possible answers according to an example embodiment. As shown in FIG. 21, the text for the question may be defined as shown at 2102 as well as whether the question is used to define a pre-filter, post-filter, or a weighting and whether a response to the question is required or optional as shown at 2104. The type of user interface element for answering the question may also be specified as shown at 2106, such as multiple choice answers, a check box, a sliding scale or other input mechanism. As shown under “Possible Answer Details” in FIG. 21, a default answer may be provided as shown at 2108 as well as choices for other possible answers as shown at 2110.
Question Flow. The order in which a user answers the questions is generally linear. However in certain cases the answers to the previous (or conditional) questions may result in the user being asked questions in order to refine their selection further. These further questions are only relevant as long as the answer to the conditional questions remains the same. FIG. 22 is a flow chart illustrating an example question flow according to an example embodiment. FIG. 22 illustrates an example question flow in beginner mode for an attribute category of “Risk and Return”. As shown in FIG. 22, a user may first be asked to indicate a risk & return trade off by using a slider user interface element. The user may then select an age group from a list. The user may then select an investment time horizon from a list. The user may then indicate the user's attitude about past performance using a radio dial user interface element. The responses from this question flow may be stored in the User Fact data structure for use by the expert system.
Profile/View Questions. In an example embodiment, the User Fact data structures may have two distinct sub-sections. The first section may include all questions which relate to a user's objective or “profile”. The profile is a collection of the user's preferences or in the case of investment products the user's investment bias's. These could be his attitude towards risk or fees. Rankings are calculated by analyzing the user's profile. The second subsection may include the user's view of his profile. A view is essentially a filtered subset of the user's ranked results. Multiple views could be combined with a profile in order to deliver a ranked subset of results which give the user a unique perspective of how his preferences apply in a variety of circumstances. Alternatively, the views may serve as an organizational principle. In the case of funds, an organizational principle may be viewing his ranked results per asset class or per geographical location.
Specified/Unspecified Questions. The user may decide to leave certain questions unanswered. These questions may not be vital to delivering a ranked result, but only assist in refining the results. Which questions the user has answered, and which the user has chosen to ignore are contained within the fact.

Decision Tables. In example embodiments, decision tables are used to model the logic of product domain experts. The purpose is to evaluate the user's profile and depending on certain logical conditions being met, undertake a number of actions which result in the weighting (importance) of each product attribute, how that attribute is evaluated, and the filters for a product data set being generated for later use by the ranking engine. In the case of investments, the logic modeled within the decision table may take into account a user's current station in life and theory-backed recommendations on which investment criteria would be more applicable to a user should they decide to make an investment. Multiple conditions may be evaluated at once and affect many more attributes than a user could comprehend at one time. In an example embodiment, the decision table is converted into a rules language which is interpreted and processed by a rules engine. In example embodiments, the combination of multiple conditions and their resulting actions is called a rule.

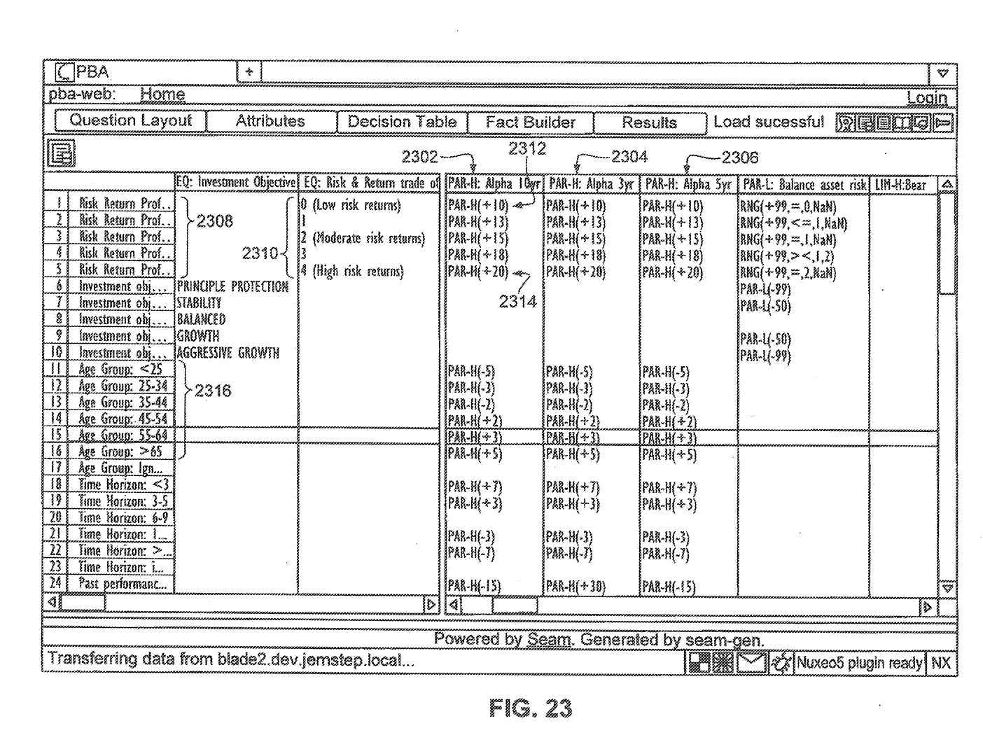

FIG. 23 shows an example of a decision table according to an embodiment. FIG. 23 shows how answers to questions related to the attribute category of “Risk and Return” may be used to adjust weightings for individual attributes in that attribute group, such as “Alpha 10 yr”, “Alpha 3 yr” and “Alpha 5 yr” (see 2302, 2304, 2306). The first column of FIG. 23 shows the name of the question from the question flow. Each row may include a possible answer for the question. For example, rows 1-5 relate to a question regarding the user's “Risk Return Profile” (see 2308). The possible answers for the mode shown (beginner mode) range from 0 (Low risk profile) to 4 (High risk returns) as shown in the third column of FIG. 23 (see 2310). If the particular answer is provided, the actions shown in the same row on the right side of the table are taken. The actions that may be taken are described further below. An example action is adjusting the weighting for an attribute within the attribute group. For example, if the user selected a risk/return profile of 0 (Low risk return), then the weighting for Alpha 10 yr is adjusted by +10 as indicated by the action “PAR-H(+10)” as shown in the first row, fourth column of FIG. 23 (see 2312). On the other hand, if the user selected a risk/return profile of 4 (High risk returns), then the weighting for Alpha 10 yr is adjusted by +20 as indicated by the action “PAR-H(+20)” as shown in the fifth row, fourth column of FIG. 23 (see 2314). Similarly, rows 11-16 show possible answers for the question regarding the user's age group (see 2316). For each row, a set of weighting adjustments is shown in columns 4, 5 and 6 for the attributes “Alpha 10 yr”, “Alpha 3 yr” and “Alpha 5 yr”. In this way, the impact of the answer to each question for the attribute group “Risk and Return” can be mapped to specific actions that adjust the weightings for each individual attribute in the group or to generate a filter.

The user's responses to the profiling questions may include information or attributes about the user or about the product attributes or other information that can be used by the rules to adjust weightings and/or generate filters and/or change the manner in which a product attribute is evaluated. For example, the User Fact may include information about attributes of the user such as age, income level, desired retirement age or other relevant information. The rules in the decision table can then be used to adjust weightings for product attributes in the relevant attribute group based on the information about the user. While the user does not directly provide an importance rating for a particular product attribute, the expert system can adjust the weightings that the system uses for ranking based on information about the user. The amount that the overall weighting for a particular attribute is determined by information about the user (as opposed to the user's own importance ratings for product attributes or attribute groups) may vary by mode of operation. Beginner modes may derive most of the weightings indirectly from information about the user's situation (for example, income level age, etc.) and more advanced modes may rely more heavily on information about the user's preferences with respect to product attributes or attribute groups (for example, risk/return profile). In expert mode, the user may provide importance ratings for individual product attributes that are used to directly determine weightings for individual product attributes.

In example embodiments, a response to a single question may impact a large number of individual product attributes and responses to a series of questions may incrementally adjust the same product attributes based on the answer to each question. In an example embodiment, the cumulative adjustments based on the responses to a series of questions may be used to determine the overall importance or weighting assigned to a particular product attribute. For example, in some embodiments, an attribute group may have 2, 3, 4, 5, 10, 15, 20 or more individual product attributes. The response to a single question may result in incremental adjustments to a subset or all of these product attributes. For example, the weightings for 2, 3, 4, 5, 10, 15, 20 or more product attributes may be adjusted based on the response to a single question. The next question in the series may also result in an adjustment to the weighting for some or all of the same product attributes. In some embodiments, the same 2, 3, 4, 5, 10, 15, 20 or more product attributes may be adjusted based on the response to the next question in the series. In some examples, the weightings for different product attributes may be adjusted based on the response to the next question or some of the same product attributes and some different product attributes may be adjusted based on the response to the next question. This process may continue for responses to each of the question in the series of questions, resulting in a cumulative overall weighting being generated for each product attribute in the attribute group. In other instances, responses to particular questions may result in a particular value being set for the weighting for the product attribute. Some questions may be used to generate filters or change the manner of evaluation rather than to adjust weightings.

The number of questions in a series that affect weightings for an attribute group may be less than the number of product attributes in the attribute group. For example, the series of four questions in FIG. 22 may be used to adjust the weighting for more than four product attributes in the attribute group for “Risk and Return”. For example, the responses to these questions may be used to adjust 5, 6, 10, 15 or more product attributes. For example, the responses to these questions may be used to adjust weightings for product attributes such as 10 yr Alpha, 3 yr Alpha, 5 yr Alpha, 10 yr Beta, 3 yr Beta, and 5 yr Beta. As a result, in a beginner mode, a relatively small set of general questions may be used to generate weightings for a larger number of individual product attributes without exposing the user to the underlying complexity. In some examples, the number of questions in a series may be greater than the number of product attributes whose weightings are adjusted. For example, a series of questions may be associated with an attribute group for taxes and may ask the user a number of questions about the user's income level, federal tax bracket, state tax bracket and other information that impacts the user's taxes. However, these responses may be used to generate weightings for a smaller number of product attributes such as attributes for capital gains, turnover and unrealized gain percentage. In an example embodiment, there may be a number of different attribute groups, such as 2, 3, 4, 5, 10, 15 or more. The number of questions associated with each attribute group and the number of product attributes impacted by each series of questions may vary by attribute group. Some attribute groups may have a large number of questions impacting a smaller number of product attributes and some attribute groups may have a smaller number of questions impacting a larger number of product attributes. In some embodiments, this may depend upon the mode of operation being used for the attribute group. For example, a few high level questions may be used to generate weightings for a large number of product attributes in a beginner mode. When an expert mode is used for the same attribute group in an example embodiment, a user may be asked a question for each product attribute (for example, to allow the user to provide an individual importance rating for each product attribute). In addition, in some embodiments, the mode may be changed from one attribute group to another for the same user.

The above example describes rules based on a user's response to questions contained in a User Fact data structure. In other embodiments, user profile information may be obtained in other ways and it may not be necessary to ask the user a series of profile questions to obtain some or all of the information used to generate weightings and filters. For example, user information, such as age or income level, may be available from other sources and can be used to generate weightings based on rules in a manner similar to that described above. Some example embodiments may use any source of information regarding user attributes, importance ratings and other information regarding a user to generate weightings for product attributes within an attribute group and are not limited to a user's response to profiling questions. The user attributes or profile information for different categories or topics may be associated with attribute groups and rules in a decision table may be use to adjust weightings for product attributes in the attribute group or to generate filter based on product attributes in a manner similar to that described above with respect to a user's responses to profiling questions.

The conditions and actions used for rules in an example embodiment will now be described in further detail.
Conditions. In an example embodiment, logical conditions are independently evaluated in a sequential order to produce a list of actions. Each action affects the weighting of an attribute or generates a filter statement. Conditions are directly linked to the questions answered by a user. Example conditions are: “If the duration of the investment is greater than 3 years then” or “if my investment objective is principle protection then”. In the example decision table of FIG. 23, the conditions are indicated on the left side of the decision table and correspond to the answers to the profile questions provided by the user. Each row is a condition that may be satisfied by a user's answer to a question. On the left side of the table for each row, the table specifies actions to be taken if the condition is met. Actions may be taken with respect to each attribute in the attribute group.
Actions. The following are types of actions that may be specified in an example embodiment:
   Actions Affecting Attribute Evaluation. Attributes may be evaluated in two ways. Firstly, they may be evaluated against their peers (the attribute of other products in its set), and secondly, against a benchmark. The expert system sets how the attribute is evaluated. The attribute is assigned a score as to how best they fair in this evaluation, the score is assigned by the next phase of the process which is the ranking engine. An example of a peer evaluation is determining how the APR offered by a credit card fairs in relation to the market assuming a lower interest rate is better. As example of a benchmark evaluation is whether a ratio (for example, beta) is within a particular range or in line with its index.
   Actions Affecting Attribute Weightings. The attribute weighting represents the proportional importance of that attribute overall. This value can either be a running total throughout the rules processing or it can be explicitly set by an individual rule. Furthermore, the value by which the running total is manipulated or set by may be set by the product domain expert or retrieved directly from a value set by the user. An example of the first case is that if a user is younger than 25 years old, the domain expert chooses to reduce the importance of alpha over ten years by a constant value. An example of the latter is if the user specifies his income importance as 8 on a scale of 1-10, the importance of the fund producing income may be adjusted by the user's value of 8.
   Actions Affecting Filters. Certain actions deliberately reduce the size of the product set to be ranked. This occurs if the product domain changes or if a user wants to view a subset of the ranked set filtered by an arbitrary attribute.
Backtracking (Profile Explanations). In an example embodiment, for each rule which affects the weightings, an explanation detailing the domain expert's motivation for making the weighting change may be recorded in the decision table. These explanations may be delivered to the user so they may have a complete record of the expert systems logic. The detail of the description is in proportion to the level of expertise chosen by the user for the applicable question group. An example of a backtracking item would be: “Age and Risk: Younger than 25 years old—You told us you are younger than 25, and therefore far from retirement. Generally, the younger you are, the less vulnerable you are to most kinds of risk. Jemstep took this into account in determining the risk tolerance in your ranking.”

### Processing

In an example embodiment, a rules engine is used to produce the output structured by applying the user fact to the expert logic. The weightings, filters and evaluators are stored in a data structure for use in the ranking process. In example embodiments, the weightings may be stored in a Weighting Data Structure in memory. The Weighting Data Structure may include the weighting to use for each product attribute during the ranking process. As described above, the weightings are determined based on the profiling information provided in the User Fact data structure and the logic in the Decision Tables used by the expert system. While the user may answer questions for more general attribute groups, weightings may be provided for each individual product attribute based on the rules in the decision table. An Attribute evaluation Data Structure may also be provided that indicates how each attribute should be evaluated as described above, for example against peers or against a benchmark. This is also determined based on the User Fact and rules in the Decision Table. A Filter Data Structure is also provided which indicates any filters to be applied to each attribute for the ranking. This is also determined based on the User Fact and rules in the Decision Table. As described above in connection with FIG. 20, the expert system also generates a data structure indicating the weightings for each attribute group. In an example embodiment, the overall weighting of each group is determined by the sum of the attributes within that group. As described above in connection with FIG. 20, the expert system also generates a data structure indicating Backtracking information describing how the User Fact impacted the weightings, filters and evaluation. This data structure may include a list of all backtracking items organized by question groups.

As described above, example embodiments may use scaffolding and balancing to adjust the weightings depending upon the level of expertise of the user. The final weightings for each attribute may be bounded by minimum and maximum values that are more restrictive for modes of operation for users having lower levels of expertise and may be less restrictive for more advanced users.

In addition, balancing of weightings per group may also occur during processing in example embodiments. The balancing is used to prevent one group of attributes completely out-weighting or dominating another when it is not intended to. During the construction of the decision tables, a domain expert will intuitively balance the effect of the weightings per group in order to ensure each group meets his views as to their relative importance to other groups. The domain expert supplies this list of guidelines, in the form of ranges of values, to the expert system. The expert system then invokes balancing cheeks against the resulting weightings using these guidelines. If the checks fail the expert system may either flag an error or make automatic adjustments depending on the implementation. The automatic adjustments increase the individual attribute weightings within a particular group proportionally in order to bring that group's overall weighting in line with the expert's guidelines. The extent of the balancing is determined by the user's level of expertise in the product.

The balancing is increasingly important when dealing with users of a lower expertise. The balancing protects the user from making unorthodox choices or choices which fly in the face of the domain expert's point of view. The strength of the effect of the balancing is inversely proportional to the expertise of the user. Generally users of lower expertise will have to adhere to the balancing guidelines prescribed by the domain expert. The amount of balancing decreases within increasing levels of expertise as indicated by different modes selected by the user. In some embodiments, an expert mode may be provided that caters to users who themselves are domain experts. The expert may set their own balancing guidelines or completely ignore them, for better or for worse. In some embodiments, a user in expert mode may evaluate each individual product attribute and assign any weighting to the attribute. In some embodiments, the mode may be changed between attribute groups, so some attribute groups are scaffolded and balanced based on one level of expertise (for example, beginner mode) and other groups are scaffolded and balanced based on a different level of expertise (for example, advanced mode) or not at all (for example, based on an expert mode).

### Ranking Methodology

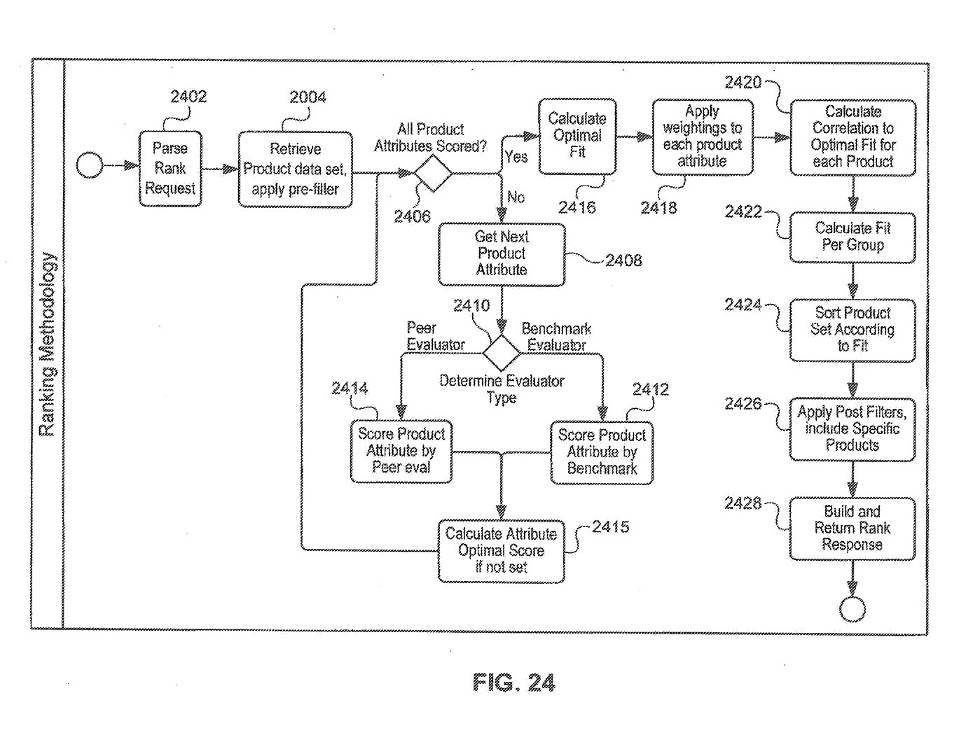

In an example embodiment, the ranking methodology is implemented in the ranking engine. In an example embodiment, the ranking engine is a software module executed on the server as described in connection with FIG. 20. In an example embodiment the ranking engine is product agnostic, and takes all its direction from the expert system. The output data structures from the expert system are used as inputs to the ranking engine. The manner in which a ranked result set is derived is explained in detail below. FIG. 24 is a flow chart illustrating an example method for ranking products implemented by the ranking engine in an example embodiment.

In the example embodiment of FIG. 24, a rank request is provided to the ranking engine. As shown at step 2402, the rank request is parsed by the ranking engine. The rank request includes the output data structures from the expert system and meta data regarding the request. As described above, the output data structures from the expert system may include a Weighting Data Structure with weightings to use for each product attribute during the ranking process, an Attribute Evaluation Data Structure indicating how each attribute should be evaluated, and a Filter Data Structure specifying any filters to be applied to each attribute for ranking. The request meta data may be used to direct the behavior of the ranking engine. The request meta data may include meta data provided by the client in the User Fact data structure as described in connection with FIG. 20. The meta data may be used to direct implementation specific behavior and may be independent of the ranking methodology. For example, the entire ranked result set may be accessible. However, for performance reasons, the request meta data may specify that only sections of the result set are returned back to the user at one time. This allows the user to page through the set of ranked products like one would the results of a search engine. The request meta data may also include a list of products which the user wants to include in the ranking. These could be products that the user owns, or wishes to evaluate in conjunction with the ranked result set, even if they do not otherwise fall within the product domain and filters selected for ranking,

As shown at step 2404 in FIG. 24, the relevant product data set is retrieved and any pre-filters are then applied. The product data set includes data for all products in the product domain being ranked. The product data may be stored in a database on the server and may include, for each product, data values for each product attribute for that product. In example embodiments, the data values may be the actual values associated with a product attribute for a particular product, such as the actual APR for a particular credit card or the actual 3 year Load Adjusted Returns for a particular mutual fund. For example, if the product domain to be ranked is mutual funds, the database may include all mutual funds known to the system and, for each, data values for each of the individual product attributes shown in FIG. 18. The data values may be obtained from information fields associated with each product as described for other embodiments above. In example embodiments, the product data may be obtained from a database, data feed, web service, APIs or other data source. Pre-filters are applied at step 2404 to reduce the product data set down to all relevant products within the product domain. The pre-filter is determined by the expert system. The user's answers to questions may be used to generate filters. For example, as shown at 2104 in FIG. 21, questions may be specified using a check box to indicate whether the question is used to determine a pre-filter, post-filter or weighting. When s question is specified for determining a pre-filter, the expert system may generate a pre-filter based on the answer provided by the user. For example, a question may ask the user whether the user wants to rank stock mutual funds or bond mutual funds. The answer may be used to pre-filter the product data set to include only stock mutual funds or only bond mutual funds. The pre-filters completely eliminate products from the product data set being ranked. In contrast, weightings determine how an attribute impacts ranking, but do not eliminate products from the ranking. The pre-filters are applied to the product data set in the ranking engine as shown at step 2404. In an example embodiment, the pre-filter selects the product identifiers and all attributes associated with the product from a relational database. This is an example only, and other embodiments may use other types of data management systems or other types of data sources.

The next steps in the process involve evaluating each attribute for each product and generating a score which represents how successful the product is in meeting that evaluation. As shown at step 2406 in FIG. 24, the ranking engine determines whether all products attributes have been scored. If not, then the ranking engine gets the next attribute from the product data set as shown at step 2408. The ranking engine then determines the type of scoring evaluation to use for the product attribute as shown at step 2410. The type of evaluation is determined by the expert system and applied by the ranking engine. The type of evaluation may be set by the expert for different attributes or may be determined by the expert system based on the user's answers to questions and the rates defined in the decision table based on those answers. The per attribute scoring process against a benchmark as shown at step 2412 and against peers as shown at step 2414 is described further below.

When scoring against a benchmark in an example embodiment, that benchmark may be a single value (for example, alpha of 0.5), an index (for example, 3 year performance against the S&P 3 year performance) or against a category or sector (for example, the 3 year performance of all stocks within the same sector). In the case of a provided value, the expert system may set the value to evaluate against in an example embodiment. In other cases, an indicator of the index or category may be provided in an example embodiment and that data is retrieved from memory or a database for use in scoring.

In an example embodiment, the manner in which an attribute is compared to a benchmark may be specified by a logical operator. In an example embodiment, the logical operator may be any form of Boolean operator. Some examples are ‘<x’, ‘<=x’, ‘>x’, ‘>=x’, ‘=x’ and >x&&>y (between), where x and y are two benchmark values to compare against. In an example embodiment, if the attribute being evaluated meets the logical condition specified by the logical operator, the attribute is awarded the highest possible score for that attribute. The actual score may be arbitrary. For practical reasons, in an example embodiment, we use ‘1’ with the lowest possible score being ‘0’. In an example embodiment, attributes for products which do not meet the logical condition are based on the highest possible score, but are reduced using an exponential decay process. The decay constant is set by a function of the maximum or minimum attribute value and the distance of that value from the benchmark values. This is an example only and other embodiments may use other methods for scoring attributes against a benchmark.

In an example embodiment, attributes may also be scored against peers as shown at step 2414. In order for an attribute to be evaluated against its peers, a relative performance goal may be determined for the attribute type. In example embodiments, the performance goal may be based upon an evaluation against the highest value or the lowest value for an attribute. For example, in the case of credit cards, the APR attribute for each credit card may be evaluated against the lowest APR. In the case of mutual funds, 3 year performance may be evaluated against the highest 3 year performance, or the fees attribute may be evaluated against the lowest fees. In an example embodiment, the attribute score may be determined by the number of standard deviations the value is above or below the mean for that attribute.

After the attribute is scored for each product, the ranking engine calculates an optimal score for the attribute if it has not been set as shown at step 2415. For each attribute and its evaluation function in a product data set, the optimal or best possible score may be calculated in an example embodiment. In the ease of an attribute evaluated against a benchmark, the benchmark may be used as the optimal score. In the case of an attributed evaluated against peers, the optimal score may be the minimum or the maximum score depending on the performance goal.

The above scoring process is then repeated until all product attributes have been scored as indicated at step 2406. After all product attributes have been scored for all products, the ranking engine then determines an optimal fit as shown at step 2416. At step 2416, the weightings for each product attribute are applied to the optimal score of each attribute. The result or “weighted optimal score” is the product of the optimal score and the proportional weighting of the attribute (as previously determined by the expert system). The result of this function is a series which is called the optimal fit. This series reflects the optimal score for each attribute weighted by the weightings for each attributed generated by the expert system based on the user's profile (as reflected in the User Fact data structure).

As shown at step 2418, the weightings may also be applied to the scores for each attribute for each product in the filtered data set. The result or “weighted score” is the product of the score and the proportional weighting of the attribute. As shown at step 2420, the ranking engine may then calculate a correlation of the series of weighted scores for each product to the optimal fit. The higher the correlation, the closer the product matches the optimal fit. This determines, for each product, how well it matches the weighted scores of the optimal fit and therefore how well the product meets the user's requirements. A value (called overall fit) is assigned to each product which represents this match. Example embodiments may use various methods for calculating an overall fit. For example, a correlation coefficient may be calculated or a least squares method may be used for determining the overall fit in some embodiments.

As shown at step 2422, this function may then be repeated for each group of attributes in order to determine the fit per group. The correlation of the weighted scores for a product in each attribute group may be determined relative it the weighted optimal scores for those attributes. This allows ranking results to be sorted or evaluated by rankings for attribute groups as well as by overall fit.

As shown at step 2424, in an example embodiment, the products are then sorted in descending order by their overall fit. In an example embodiment, the product with the highest fit is ranked #1 (the ranking of the product against the user's preferences). The implication of this function is that products are ranked at an attribute level or a leaf level, even though user profile information may be determined based on answers to questions associated with attribute groups at a high level of abstraction.

As shown at step 2426, post filters may then be applied. In an example embodiment, the post filters are optional filters supplied to the ranking engine which, once applied, result in a subset of rankings from the calculations of ranking based on overall fit as described above. A list of specific products to rank (which may be specified in the request meta data as described above) may be included within the subset regardless of whether they match the post-filter or not. The resulting subset can maintain their original rankings from the super-set, or alternatively may have their rankings modified to represent their positions within the subset. For example, a product which ranked #5 in the super set and has the highest overall fit within the subset may keep its rank at #5, or alternatively will be modified to have a rank #1 in the subset, the purpose of the post-filters is to allow a user a finer-grained control of the rankings returned. The user may wish to see a subset of products. For example, the user may request a ranking of all funds based in china, but may also explicitly request rankings for one or more U.S. based funds to be included in the result (as part of the request meta data as described above). The result of which may be a subset of all ranked china funds with the ability to compare how they rank compared to the user's specified U.S. funds. In an example embodiment, these products have to exist within the product domain enforced by the pre-filters (because the post-filter are merely a view of products within the product domain. A further example of the use of post-filter is in the case of investment amount. The user may wish to see the rankings of a subset of products with a minimum investment amount of $1000.00, but then compare those rankings (or fit) to the ranking of a fund which has a minimum investment amount of $10,000.00

As shown at step 2428, the ranking engine then builds and returns a rank response. In an example embodiment, the ranking engine returns the following data structures as part of the rank response. These structures are the result of the ranking process and allow for transparency of the ranking process.

Total Results/Total Ties/Unique Ranks
Total results is the number of products in the ranked set.
Total Ties are the number of products which have an identical overall fit.
Unique Ranks is the difference between the Total Results and Total Ties

Product Rankings, Product Identifier, Product Ties, Product Index within Ranked Set, Overall Fit. For each product, the following is returned:
the ranking of the product e.g. #1, #10, and so on.
A unique number identifying the product
the number of products that this particular product has the exact same overall fit as
the index of the product within its ranked set. This number is used to retrieve the products which come before or after this product.
The overall fit of the product, determined as described above

Results of the List of specified products. For each value described in the preceding paragraph (ranking, unique number, index and overall fit), the same are returned for each product within the list of specified products to be ranked as indicated in the request metadata.

Fit per Attribute Group per Product. For each product returned in the two preceding paragraphs, a list of the fit per group per product is also returned.

Standard Score of each Attribute of each Product. In order to gauge the performance of attribute against its peers, a standard score is returned.

Score/Weighting Debugging Attributes. For debugging purposes, the attribute scores (including the optimal fit) and the weighted scores may be returned in some embodiments depending on the implementation.

Filter Exclusion Indicator. If a product within the list of specified products is excluded from the ranked set as it does not match the pre- or post-filters, a value is returned that indicates at which stage the product was excluded.

As shown in FIG. 20, the ranking engine on the server may then send the rank response (or data formatted for display by a browser based on the rank response) to the client system as shown at 2020. Ranking information from the rank response may then be displayed to the user by the browser on the client system.

### Summary

Example embodiments of the present invention may be used to provide an impartial and objective web application for intelligently locating a product, where the search for the product is performed over a computer network that is accessible to users through any internet access device, including, personal computers, laptops, mobile telephones, and many others. Example embodiments of the invention accept predefined and/or open-ended search criteria and user profile data and responds to user direction to access one or many data sources in order to identify the optimal search candidate within a finite set of possible candidates constructed for a predefined problem. The located product is selected by its relevance to a searcher and, more particularly, by its correlation to attributes associated with the searcher. Embodiments of the present invention locate not just web pages that reference, link, or offer a desired product, but returns a list of results ranked by how well the product fits the searcher's needs and the searcher's situation.

An example embodiment of the present invention produces a ranking of relevant products by receiving a search topic from a user and one or more attributes associated with the user. The attributes are factors, such as demographics or situational data specific to the user. The example embodiment then searches multiple information locations for the search topic and also searches at least one information field connected to each information location and associated with the topic. The example embodiment then associates content in at least one of the information fields with at least one of the attributes. By “associating,” the example embodiment is making a logical correlation between the content of one of the information fields and one of the attributes input by the user. This correlation may not be direct. For example, the user may enter the “attributes” of his total debt and his income. The example embodiment may “associate” these attributes to an information field containing a maximum limit of a loan and also to a minimum credit score. The user's credit score can be calculated by the example embodiment based on debt vs. income. The information fields are then prioritized, thereby creating a hierarchy of factors based on importance or relevance. For instance, the user may wish to find a credit card with the highest credit limit so he can move debt, rather than worry about an interest rate. Based on the prioritization, the products are ranked against each other.

Embodiments of the present invention build a comprehensive profile of users by monitoring user click-through events and recommendation acceptance. This comprehensive set of mine-able data increases the ability to recommend suitable products and may lead to a sustainable source of income.

In example embodiments, the system has the potential to cause providers to make their products more competitive and attractive to consumers by offering quantifiable benefits. Although qualitative aspects of a product are not disregarded (users are allowed to rate this separately), the recommendation of which products(s) best fit(s) the user's profile and search requirements is presented. This, coupled with the ability to present recommendations of products far beyond the average consumer's top-of-mind awareness, is a great leveler of the playing field which provides a huge advantage to consumer decision making.

Example embodiments of the present invention are able to affect multiple industries, which included investments, borrowing, insurance, travel, healthcare, telecommunications, education, and many others.

Example embodiments of the present invention may be used to provide many advantages. For one, the results (rankings) are particular to the user conducting the search and have no bearing on other users of the system. Specifically, example embodiments of the present invention make each search tailored only to the user conducting the search. Example embodiments of the present invention rate products and services on their attributes and the relevance of each attribute to the searching user's profile.

An example embodiment of the invention may be impartial and objective because it is based on published, industry-specific data. Queries processed by the system are those which are directed at a particular industry in order to find a quantifiable result. This could be a financial rate comparison, top-rated service provider, or a product which best meets the needs of the user. The result of a query is impartial as the entity providing the service gains no financial reward from making its recommendation.

Furthermore, the knowledge base and data repository of an example embodiment of tbe present invention is built on published information (e.g., web data) and/or data that is compiled by a trustworthy, impartial, third party. The operator of an example embodiment of the present invention is not required to obtain subscriptions from service providers nor prioritize results based on any financial incentives. Advantageously, embodiments of the present invention create an automated “live” data repository which is continuously up-to-date and actively monitoring changes in the marketplace and seeking new providers and products.

Web users are generally familiar with formulating natural-language queries in order to receive a list of possible answer, then manually filtering the results in order to locate the most relevant answer. However, the ability to formulate an effective natural language query depends on the level of sophistication a user has within a particular field.

Though use of an example embodiment of the prevent invention, users are guided through a question/answer-based expert system assists the user in narrowing the query and filtering results to find the most relevant and beneficial single result within the target industry. The expert systems are industry-specific and developed in conjunction with experts operating in that particular field. This allows an example embodiment of the present invention to provide a service to both sophisticated and unsophisticated users alike, allowing both to achieve the best possible result.

One further advantage is that an example embodiment of the present invention is able to present the most relevant result only. In such an embodiment, the ultimate goal is to offer the single best-suited result based on the user's query criteria and requirements, i.e., one query equals one result.

Additionally, where possible and/or applicable, the example system facilitates the transaction between the user and the service provider. This may be in the form of an online transaction or simply the presentation of contact details.

Example embodiments of the indention advantageously provide a diverse application platform that assists the user in making the most informed decision and monitoring the effectiveness of that decision over any given length of time.

While example embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer implemented method for ranking a plurality of products, wherein each product is associated with a plurality of product attributes, the method comprising:
specifying a plurality of attribute groups, wherein each attribute group is associated with a plurality of the product attributes;
providing a series of questions associated with each attribute group, each series of questions associated only with a respective attribute group;
obtaining responses to each series of questions from a user;
applying a set of rules to the responses obtained from the user for each series of questions, the responses associated only with the respective attribute group and, upon application of the set of rules, being used to generate weightings for the product attributes in the attribute group associated with the respective series of questions;
using a processor to score each of the products for each of the product attributes;
generating a weighted score for each of the product attributes by applying the weighting for the respective product attribute to the score for the respective product attribute for each of the products; and
ranking the products based on the weighted scores.
